(19) United States
(12) Patent Application Publication
(10) Pub. No.: US 2026/0173148 A1
(43) Pub. Date: Jun. 18, 2026

(54) RANDOM ACCESS PROCEDURES TO ACCESS VIRTUAL CELLS IN WIRELESS COMMUNICATIONS SYSTEMS

(71) Applicant: QUALCOMM Incorporated, San Diego, CA (US)

(72) Inventors: Aria HASANZADEZONUZY, Chatham, NJ (US); Kianoush HOSSEINI, San Diego, CA (US); Alberto RICO ALVARINO, San Diego, CA (US); Naeem AKL, BRIDGEWATER, NJ (US); Gokul SRIDHARAN, Sunnyvale, CA (US)

(21) Appl. No.: 18/981,411

(22) Filed: Dec. 13, 2024

(51) Int. Cl. H04W 74/0833; H04W 12/08

(52) U.S. Cl. CPC H04W 74/0833; H04W 12/08

(57) ABSTRACT

Methods, systems, and devices for wireless communications are described. A wireless communications system may implement a virtual cell (vCell), which may include a grouping of a set of serving cells. Accordingly, a user equipment (UE) may perform a random-access channel (RACH) procedure to access the set of serving cells of the vCell. To do so, the UE may transmit, via a first serving cell of the vCell, a first message to access the vCell. In response, the UE may receive, via the first serving cell or a second serving cell of the vCell, a second message of the RACH procedure. The UE may communicate with the set of serving cells of the vCell according to a successful performance of the RACH procedure.

### FIELD OF TECHNOLOGY

The following relates to wireless communications, including random-access procedures to access virtual cells (vCells) in wireless communications systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting, via a first serving cell of a virtual cell (vCell), a first message of a random-access channel (RACH) procedure to access a set of serving cells of the vCell, receiving, via the first serving cell or a second serving cell of the vCell, a second message of the RACH procedure in response to transmission of the first message, and communicating via the set of serving cells of the vCell in accordance with successful performance of the RACH procedure.

A UE for wireless communications is described. The UE may include one or more memories storing processor executable code, and one or more processors coupled with the one or more memories. The one or more processors may individually or collectively be operable to execute the code to cause the UE to transmit, via a first serving cell of a vCell, a first message of a RACH procedure to access a set of serving cells of the vCell, receive, via the first serving cell or a second serving cell of the vCell, a second message of the RACH procedure in response to transmission of the first message, and communicate via the set of serving cells of the vCell in accordance with successful performance of the RACH procedure.

Another UE for wireless communications is described. The UE may include means for transmitting, via a first serving cell of a vCell, a first message of a RACH procedure to access a set of serving cells of the vCell, means for receiving, via the first serving cell or a second serving cell of the vCell, a second message of the RACH procedure in response to transmission of the first message, and means for communicating via the set of serving cells of the vCell in accordance with successful performance of the RACH procedure.

A non-transitory computer-readable medium storing code for wireless communications is described. The code may include instructions executable by one or more processors to transmit, via a first serving cell of a vCell, a first message of a RACH procedure to access a set of serving cells of the vCell, receive, via the first serving cell or a second serving cell of the vCell, a second message of the RACH procedure in response to transmission of the first message, and communicate via the set of serving cells of the vCell in accordance with successful performance of the RACH procedure.

Some examples of the method, UEs, and non-transitory computer-readable medium described herein may further include operations, features, means, or instructions for transmitting, via the first serving cell, a third message of the RACH procedure in response to reception of the second message and receiving, via the first serving cell or the second serving cell, a fourth message of the RACH procedure in response to reception of the third message, where communicating via the set of serving cells may be further in accordance with reception of the fourth message.

In some examples of the method, UEs, and non-transitory computer-readable medium described herein, the first message, the third message, or both, include an indication that the UE may be to access the vCell as a result of the successful performance of the RACH procedure.

Some examples of the method, UEs, and non-transitory computer-readable medium described herein may further include operations, features, means, or instructions for transmitting, prior to a security establishment procedure of the RACH procedure, signaling that indicates one or more serving cells of the set of serving cells via which the UE may be to perform the RACH procedure, where the one or more serving cells include the first serving cell, the second serving cell, or both, and where the RACH procedure may be performed in accordance with the signaling.

In some examples of the method, UEs, and non-transitory computer-readable medium described herein, the signaling further indicates at least a subset of serving cells of the set of serving cells with which the UE will communicate with after the successful performance of the RACH procedure and the UE communicates via the subset of serving cells in accordance with the signaling.

Some examples of the method, UEs, and non-transitory computer-readable medium described herein may further include operations, features, means, or instructions for receiving an indication of one or more resources allocated for transmission of the signaling, where the signaling may be transmitted via the one or more resources.

In some examples of the method, UEs, and non-transitory computer-readable medium described herein, the second message may be received via the first serving cell and the method, apparatuses, and non-transitory computer-readable medium may include further operations, features, means, or instructions for receiving, in response to the successful performance of the RACH procedure, a set of physical RACH (PRACH) resources associated with an additional serving cell of the set of serving cells of the vCell and transmitting a message to the additional serving cell of the vCell via the set of PRACH resources, where the message indicates a subset of the set of serving cells of the vCell with which the UE intends to communicate, a set of beams usable by the UE for communicating with the vCell, or both.

Some examples of the method, UEs, and non-transitory computer-readable medium described herein may further include operations, features, means, or instructions for receiving system information (SI) associated with the vCell, where the SI indicates a mapping between one or more first beams of a first set of beams associated with the first serving cell and one or more second beams of a second set of beams associated with the second serving cell, where the first message may be transmitted via the one or more first beams associated with the first serving cell and the second message may be received via the one or more second beams associated the second serving cell in accordance with the mapping.

In some examples of the method, UEs, and non-transitory computer-readable medium described herein, the SI further indicates that the UE may be to monitor each beam of the one or more second beams for reception of the second message in response to transmission of the first message via the one or more first beams.

In some examples of the method, UEs, and non-transitory computer-readable medium described herein, the SI further indicates that the UE may be to monitor any of the one or more second beams for reception of the second message in response to transmission of the first message via the one or more first beams.

In some examples of the method, UEs, and non-transitory computer-readable medium described herein, the one or more second beams associated with the second serving cell include beam characteristics that may be the same or similar to beam characteristics of the one or more first beams associated with the first serving cell and the beam characteristics include a beam direction, a beam width, or both.

In some examples of the method, UEs, and non-transitory computer-readable medium described herein, the SI further includes a timer associated with monitoring the one or more second beams associated with the second serving cell and the method, apparatuses, and non-transitory computer-readable medium may include further operations, features, means, or instructions for monitoring, for a duration of the timer, the one or more second beams for reception of the second message and monitoring, in response to expiration of the timer and failing to receive the second message, one or more additional beams of the second set of beams associated with the second serving cell for reception of the second message, where reception of the second message may be in accordance with monitoring the one or more additional beams of the second set of beams.

Some examples of the method, UEs, and non-transitory computer-readable medium described herein may further include operations, features, means, or instructions for receiving SI associated with the vCell, where the SI indicates a set of resources for reception of the second message, a timer associated with monitoring for the second message, a priority associated with each resource of the set of resources, or any combination thereof, where each resource of the set of resources may be associated with a respective serving cell of the set of serving cells.

In some examples of the method, UEs, and non-transitory computer-readable medium described herein, receiving the second message may include operations, features, means, or instructions for monitoring, for a duration of the timer, a first resource of the set of resources associated with the first serving cell for reception of the second message in accordance with the SI and monitoring, in response to expiration of the timer and failure to receive the second message via the first resource, a second resource of the set of resources associated with the second serving cell in accordance with the SI, where the second message may be received via the second resource associated with the second serving cell.

Some examples of the method, UEs, and non-transitory computer-readable medium described herein may further include operations, features, means, or instructions for receiving SI associated with the vCell, where the SI indicates a set of resources for transmission of the first message, a probability associated with each resource of the set of resources, a selection rule associated with the set of resources, or any combination thereof, where the first message may be transmitted in accordance with the SI.

Some examples of the method, UEs, and non-transitory computer-readable medium described herein may further include operations, features, means, or instructions for receiving SI associated with the vCell, where the SI includes a set of multiple mappings, where each mapping of the set of multiple mappings indicates a correspondence between one or more first beams of a first set of beams associated with the first serving cell and one or more second beams of a second set of beams associated with the second serving cell and transmitting, via the first message, an indication of a first mapping of the set of multiple mappings, where the first message may be transmitted via a first beam associated with the first serving cell and the second message may be received via a second beam associated the second serving cell in accordance with the first mapping.

In some examples of the method, UEs, and non-transitory computer-readable medium described herein, the first message and the second message may be communicated via a first set of resources associated with the RACH procedure to access the vCell, and the first set of resources may be different from a second set of resources that may be associated with a second RACH procedure to access a second vCell.

In some examples of the method, UEs, and non-transitory computer-readable medium described herein, the first message and the second message may be communicated via a first set of resources associated with the RACH procedure to access the vCell, and the first set of resources may be different from a second set of resources that may be associated with a second RACH procedure to access the first serving cell.

A method for wireless communications by a network entity is described. The method may include obtaining, via a first serving cell of a vCell managed by the network entity, a first message of a RACH procedure for a UE to obtain access to a set of serving cells of the vCell, outputting, via the first serving cell or a second serving cell of the vCell, a second message of the RACH procedure in response to obtainment of the first message, and communicating via the set of serving cells of the vCell in accordance with successful performance of the RACH procedure.

A network entity for wireless communications is described. The network entity may include one or more memories storing processor executable code, and one or more processors coupled with the one or more memories. The one or more processors may individually or collectively be operable to execute the code to cause the network entity to obtain, via a first serving cell of a vCell managed by the network entity, a first message of a RACH procedure for a UE to obtain access to a set of serving cells of the vCell, output, via the first serving cell or a second serving cell of the vCell, a second message of the RACH procedure in response to obtainment of the first message, and communicate via the set of serving cells of the vCell in accordance with successful performance of the RACH procedure.

Another network entity for wireless communications is described. The network entity may include means for obtaining, via a first serving cell of a vCell managed by the network entity, a first message of a RACH procedure for a UE to obtain access to a set of serving cells of the vCell, means for outputting, via the first serving cell or a second serving cell of the vCell, a second message of the RACH procedure in response to obtainment of the first message, and means for communicating via the set of serving cells of the vCell in accordance with successful performance of the RACH procedure.

A non-transitory computer-readable medium storing code for wireless communications is described. The code may include instructions executable by one or more processors to obtain, via a first serving cell of a vCell managed by the network entity, a first message of a RACH procedure for a UE to obtain access to a set of serving cells of the vCell, output, via the first serving cell or a second serving cell of the vCell, a second message of the RACH procedure in response to obtainment of the first message, and communicate via the set of serving cells of the vCell in accordance with successful performance of the RACH procedure.

Some examples of the method, network entities, and non-transitory computer-readable medium described herein may further include operations, features, means, or instructions for obtaining, via the first serving cell, a third message of the RACH procedure in response to output of the second message and outputting, via the first serving cell or the second serving cell, a fourth message of the RACH procedure in response to output of the third message, where communicating via the set of serving cells may be further in accordance with output of the fourth message.

In some examples of the method, network entities, and non-transitory computer-readable medium described herein, the first message, the third message, or both, include an indication that the UE may be to access the vCell as a result of the successful performance of the RACH procedure.

Some examples of the method, network entities, and non-transitory computer-readable medium described herein may further include operations, features, means, or instructions for obtaining, prior to a security establishment procedure of the RACH procedure, signaling that indicates one or more serving cells of the set of serving cells via which the UE may be to perform the RACH procedure, where the one or more serving cells include the first serving cell, the second serving cell, or both, and where the RACH procedure may be performed in accordance with the signaling.

In some examples of the method, network entities, and non-transitory computer-readable medium described herein, the signaling further indicates at least a subset of serving cells of the set of serving cells with which the UE will communicate with after the successful performance of the RACH procedure and the UE communicates via the subset of serving cells in accordance with the signaling.

In some examples of the method, network entities, and non-transitory computer-readable medium described herein, the second message may be output via the first serving cell and the method, apparatuses, and non-transitory computer-readable medium may include further operations, features, means, or instructions for outputting, in response to the successful performance of the RACH procedure, a set of PRACH resources associated with an additional serving cell of the set of serving cells of the vCell and obtaining, at the additional serving cell, a message via the set of PRACH resources, where the message indicates a subset of the set of serving cells of the vCell with which the UE intends to communicate, a set of beams usable by the UE for communicating with the vCell, or both.

Some examples of the method, network entities, and non-transitory computer-readable medium described herein may further include operations, features, means, or instructions for outputting SI associated with the vCell, where the SI indicates a mapping between one or more first beams of a first set of beams associated with the first serving cell and one or more second beams of a second set of beams associated with the second serving cell, where the first message may be transmitted via the one or more first beams associated with the first serving cell and the second message may be received via the one or more second beams associated the second serving cell in accordance with the mapping.

In some examples of the method, network entities, and non-transitory computer-readable medium described herein, the SI further indicates that the UE may be to monitor each beam of the one or more second beams for output of the second message in response to obtainment of the first message via the one or more first beams.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports random-access procedures to access virtual cells (vCells) in wireless communications systems in accordance with one or more aspects of the present disclosure.

FIG. 2 shows an example of a wireless communications system that supports random-access procedures to access vCells in wireless communications systems in accordance with one or more aspects of the present disclosure.

FIG. 3 shows an example of a process flow that supports random-access procedures to access vCells in wireless communications systems in accordance with one or more aspects of the present disclosure.

FIG. 4 shows an example of a process flow that supports random-access procedures to access vCells in wireless communications systems in accordance with one or more aspects of the present disclosure.

FIG. 5 shows an example of process flows that support random-access procedures to access vCells in wireless communications systems in accordance with one or more aspects of the present disclosure.

FIGS. 6 and 7 show block diagrams of devices that support random-access procedures to access vCells in wireless communications systems in accordance with one or more aspects of the present disclosure.

FIG. 8 shows a block diagram of a communications manager that supports random-access procedures to access vCells in wireless communications systems in accordance with one or more aspects of the present disclosure.

FIG. 9 shows a diagram of a system including a device that supports random-access procedures to access vCells in wireless communications systems in accordance with one or more aspects of the present disclosure.

FIGS. 10 and 11 show block diagrams of devices that support random-access procedures to access vCells in wireless communications systems in accordance with one or more aspects of the present disclosure.

FIG. 12 shows a block diagram of a communications manager that supports random-access procedures to access vCells in wireless communications systems in accordance with one or more aspects of the present disclosure.

FIG. 13 shows a diagram of a system including a device that supports random-access procedures to access vCells in wireless communications systems in accordance with one or more aspects of the present disclosure.

FIGS. 14 through 17 show flowcharts illustrating methods that support random-access procedures to access vCells in wireless communications systems in accordance with one or more aspects of the present disclosure.

### DETAILED DESCRIPTION

In order to facilitate wireless communications within a wireless communications system, a user equipment (UE) may connect with a serving cell supported by one or more network entities (e.g., base stations). Some wireless networks, such as Fifth Generation (5G) networks, support carrier aggregation or multi-cell operation in which the UE first attaches to and communicates with a primary cell (PCell) (e.g., first component carrier (CC)), then may subsequently connect to other secondary cells (SCells) (e.g., additional CCs). That is, in some wireless networks, separate serving cells operate separately from one another, and may be accessed using separate random access channel (RACH) procedures or other attachment procedures to communicate with the respective cells. Further, in such wireless networks, the parameters for communicating with the PCell and the SCell may be separately configured or established. Such carrier aggregation/multi-cell configurations enable the UE to communicate via multiple cells, which may increase overall throughput and reliability of wireless communications. However, the UE may have relatively little control over which cells/CCs are configured at the UE. Further, performing multiple RACH procedures to attach to multiple cells/CCs may increase the latency with which the UE is able to connect and communicate with the respective cells.

Comparatively, some other wireless networks, such as Sixth Generation (6G) networks, may operate according to service-based access techniques, where resources are allocated based on different application/service needs for the UE. For example, in the context of a 6G network, a UE may attach, connect, or “subscribe” to a set of cells for different applications or services, such as authentication services, gaming services, and the like. In order to support such service-based access, such wireless networks may implement the concept of a “virtual cell” (vCell), which may include (e.g., be composed of) multiple serving cells, multiple sub-bands, multiple CCs, multiple portions of a sub-band, and the like. In such cases, the respective serving cells of a vCell may be grouped together to facilitate wireless communications for one or more applications/services (e.g., an “authentication” vCell that includes multiple serving cells that are grouped together to facilitate wireless communications for authentication services). By connecting with a vCell, the UE may communicate with multiple serving cells, thereby increasing bandwidth and reducing latency, among other advantages. As compared to previous carrier aggregation/multi-cell operation, in which the UE is required to perform separate RACH procedures to attach to PCells and SCells, the UE may be able to perform a single RACH procedure with the vCell to connect to and communicate with all the respective serving cells of the vCell.

For the purposes of the present disclosure, and in the context of a “vCell,” the terms “cell,” “serving cell,” “CC,” “sub-band,” and like terms, may be used interchangeably to refer to subsets of time/frequency resources of a vCell that may be aggregated, combined, bundled, or otherwise grouped together to form the vCell and to facilitate wireless communications via the vCell.

As will be described in further detail herein, the respective serving cells of a vCell may be supported by one or more network entities. That is, the respective serving cells of a vCell may be co-located (e.g., supported by a single network entity), or non-co-located (e.g., supported by multiple, separate network entities). In some aspects, communications parameters for accessing/communicating with a given serving cell 205 individually may be the same or different compared to communications parameters for accessing/communicating with the same serving cell 205 as part of a vCell 210.

As described herein, in 5G wireless networks, separate serving cells may operate separately and independently from one another and may be accessed using separate RACH procedures or other attachment procedures to communicate with the respective cells. Further, in such wireless networks, the parameters for communicating with the PCell and the SCell may be separately configured or established. As such, because a vCell may include a collection of serving cells and access to the vCell may involve access to multiple serving cells, such 5G RACH procedures may not support access to multiple serving cells of a vCell, nor be efficient for such access. Thus, techniques may be desired to perform RACH procedures to access a vCell.

The techniques, methods, and devices described herein provide for signaling techniques that enable the UE to access the vCell via one or more multiple serving cells of the vCell. For example, the UE may perform the RACH procedure to access the vCell via a single serving cell of the vCell. In such examples, the UE may transmit a first message (e.g., message 1 or message A) to the vCell via a first serving cell of the vCell, where the first message may indicate the UE is to access the vCell. In response, the UE may receive a second message (e.g., message 2 or message B) from the vCell via the first serving cell. In some other examples, the UE may perform the RACH procedure to access the vCell via multiple serving cells of the vCell. For example, the UE may transmit the message via the first serving cell. In response, the UE may receive the message via a second serving cell of the vCell.

Based on successful performance of the RACH procedure via either one or more multiple serving cells of the vCell, the UE may communicate data with the serving cells of the vCell. By enabling the UE to perform the RACH procedure across one or more multiple serving cells of the vCell, the UE may be able to access multiple serving cells of a vCell, thereby decreasing latency in communication, improving user experience, among other advantages.

Aspects of the disclosure are initially described in the context of wireless communications systems. Aspects of the disclosure are further described in the context of process flows. Aspects of the disclosure are further illustrated by and described with reference to apparatus diagrams, system diagrams, and flowcharts that relate to random-access procedures to access vCells in wireless communications systems.

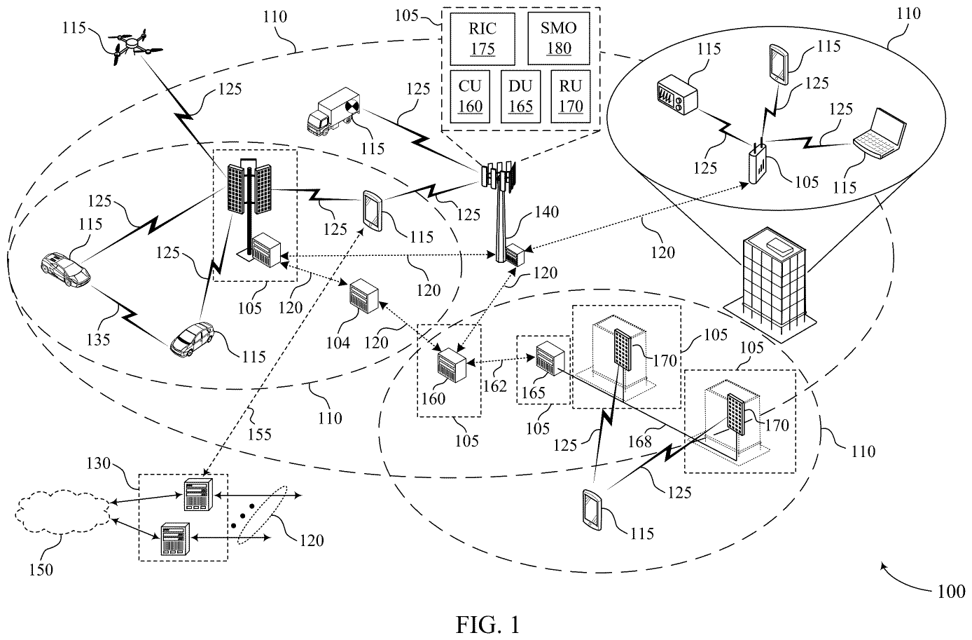

FIG. 1 shows an example of a wireless communications system 100 that supports random-access procedures to access vCells in wireless communications systems in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support random-access procedures to access vCells in wireless communications systems as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, SI), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be configured to support vCells that include multiple serving cells that are aggregated, bundled, or otherwise grouped to facilitate wireless communications. The techniques, methods, and devices described herein provide for signaling techniques that enable the UE 115 to access the vCell via one or more multiple serving cells of the vCell. For example, the UE 115 may perform the RACH procedure to access the vCell via a single serving cell of the vCell. In such examples, the UE 115 may transmit a first message (e.g., message 1 or message A) to the vCell via a first serving cell of the vCell, where the first message may indicate the UE 115 is to access the vCell. In response, the UE 115 may receive a second message (e.g., message 2 or message B) from the vCell via the first serving cell.

In some other examples, the UE 115 may perform the RACH procedure to access the vCell via multiple serving cells of the vCell. For example, the UE 115 may transmit the message via the first serving cell. In response, the UE 115 may receive the message via a second serving cell. Based on successful performance of the RACH procedure via either one or more multiple serving cells, the UE 115 may communicate data with the serving cells of the vCell.

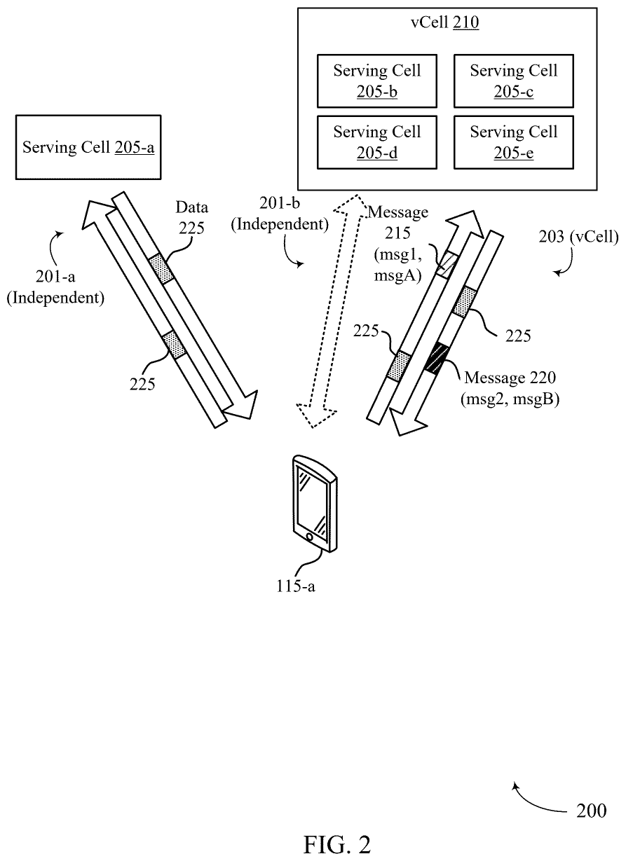

FIG. 2 shows an example of a wireless communications system 200 that supports random-access procedures to access vCells in wireless communications systems in accordance with one or more aspects of the present disclosure. The wireless communications system 200 may implement, or be implemented by, aspects of the wireless communications system 100. For example, the wireless communications system 200 may include a UE 115-a, which may be an example of a UE 115, as described herein with reference to FIG. 1. The techniques described in the context of the wireless communications system 200 may enable the UE 115-a to perform RACH

### Procedures to Access the Vcell 210.

In order to perform wireless communications, the UE 115-a may communicate with a serving cell 205, such as the serving cell 205-a. A serving cell 205 may provide the primary network coverage and connectivity to the UE 115-a via a main (e.g., primary) communication link 201-a between the UE 115-a and the wireless network (e.g., the 5G NR network). As described herein, a serving cell 205 may be referred to as a sub-band, a CC (e.g., a sub-band or a portion of a sub-band), or a frequency resource. In this regard, the terms “cell,” “serving cell,” “CC,” “sub-band,” and like terms, may be used interchangeably to refer to subsets of time/frequency resources.

In some wireless communications networks, such as 5G networks, the UE 115-a may select the serving cell 205-a (e.g., a PCell) from multiple serving cells 205 according to a reference signal received power (RSRP) of each serving cell 205, among other examples. Based on selecting the serving cell 205-a, the UE 115-a may enter a connected mode (e.g., RRC connected mode). While operating in the connected mode, if the UE 115-a supports carrier aggregation (e.g., either in the uplink or downlink), a network entity 105 may configure one or more SCells in addition to the serving cell 205-a (e.g., PCell) for communication with the UE 115-a. Accordingly, if the UE 115-a is scheduled to communicate data, the network entity 105 may activate and schedule the SCells for communications with the UE 115-a.

As an illustrative example, the UE 115-a may support downlink carrier aggregation, where the UE 115-a may receive data from the serving cell 205-a and one or more SCells simultaneously. Similarly, the UE 115-a may support uplink carrier aggregation, where the UE 115-a may transmit data to the wireless network via the serving cell 205-a and one or more SCells simultaneously.

In some cases, however, the network entity 105 may configure (e.g., allocate or assign) the one or more SCells blindly. For example, the network entity 105 may configure the SCells independent of the traffic patterns at the UE 115-a, independent of the applications associated with the UE 115-a, or independent of the coverage condition of the UE 115-a (e.g., whether the UE 115-a is located at the cell-edge or cell-center), among other examples.

As such, except for reporting capabilities associated with carrier aggregations, the UE 115-a may not have control of which SCells (e.g., CCs) are configured for carrier aggregation (e.g., in both uplink and downlink), where such configured SCells may not adequately support the applications associated with the UE 115-a and may have a negative impact on the power consumption of the UE 115-a.

In some cases, it may be desirable to configure the downlink and uplink SCells (e.g., frequency resources, CCs) according to the traffic patterns of the applications associated with the UE 115-a. For example, the UE 115-a may be enabled to access one or more SCells (e.g., the carrier aggregation combination) that are based on the service metrics at the UE 115-a, based on the coverage conditions at the UE 115-a, and based on the capabilities of the UE 115-a.

That is, the UE 115-a may be enabled to perform vCell 210 selection and re-selection with downlink and uplink serving cells 205 according to various conditions at the UE 115-a. By doing so, the UE 115-a may experience an improvement in capacity (e.g., bandwidth) for downlink communications, while also experiencing an improvement in capacity as well as coverage for uplink communications. For downlink communications, improving capacity may be a primary target or goal, while for uplink communications, depending on the UE 115 coverage situation in the cell, capacity as well as coverage may considered the main key performance indicators (KPIs).

As described herein, a vCell 210 may include (e.g., be composed of) one or more serving cells 205 (e.g., multiple sub-bands, CCs, frequency resources), where each serving cell 205 of a vCell 210 may be allocated as either an uplink serving cell 205, a downlink serving cell 205, or both an uplink and downlink serving cell 205. As an illustrative example, the vCell 210 may include four serving cells 205, such as the serving cell 205-b, the serving cell 205-c, the serving cell 205-d, and the serving cell 205-e. The respective serving cells 205 of the vCell 210 may be grouped together to facilitate wireless communications for one or more applications/services. For instance, the vCell 210 may support authentication services, where the respective serving cells 205 of the vCell 210 may be combined, bundled, or otherwise grouped together to support various aspects of the authentication services.

As described previously herein, in some wireless networks, such as 5G networks, the UE 115-a may first attach to and communicate with a PCell (e.g., serving cell 205-a), then may subsequently connect to other SCells. That is, in some wireless networks, separate serving cells 205 may operate separately from one another, and must be accessed using separate RACH procedures or other attachment procedures to communicate with the respective cells. Further, in such wireless networks, the parameters for communicating with the individual serving cells 205-a may be separately configured or established.

Comparatively, some other wireless networks, such as 6G networks, may implement the concept of a vCell 210, which may include (e.g., be composed of) multiple serving cells 205, multiple sub-bands, multiple CCs, multiple portions of a sub-band, and the like. In such cases, the respective serving cells 205 of the vCell 210 may be grouped together to facilitate wireless communications for one or more applications/services. As compared to previous carrier aggregation/multi-cell operation, in which the UE 115-a is required to perform separate RACH procedures to attach to PCells and SCells, the UE 115-a may be able to perform a single RACH procedure with the vCell 210 to connect to and communicate with all the respective serving cells 205 of the vCell 210.

In this regard, the serving cell 205-a may be an example of a “standalone” serving cell 205-a that may or may not be a part of a vCell 210, and which is accessible via a communication link 201-a. Comparatively, the vCell 210 may include a group of serving cells 205-b, 205-c, 205-d, 205-e that are aggregated, bundled, or otherwise grouped together to facilitate wireless communications via one or more communication links, such as the communication link 203.

Furthermore, in addition to facilitating communications as part of the vCell 210, the respective serving cells 205 of the vCell 210 may also support or otherwise facilitate wireless communications with the UE 115 that are separate or independent from the vCell 210 (e.g., via a communication link 201-b for “independent” communications). That is, each of the respective serving cells 205 may be accessible individually (e.g., as standalone serving cells 205, such as in 5G), and/or as part of a vCell 210 (e.g., as a group of serving cells 205, such as in 6G). For example, the UE 115-a may communicate with the serving cell 205-d as part of the vCell 210 via the communication link 203, and may additionally and/or alternatively communicate with the same serving cell 205-d separately/independently from the vCell 210 via the communication link 201-b.

In some examples, each of the serving cells 205 of the vCell 210 may be operated by a single network entity 105 (e.g., co-located). In other examples, a first subset of the serving cells 205 of the vCell 210 may be operated by a first network entity 105 and a second subset of the serving cells 205 of the vCell 210 may be operated by a second network entity 105 (e.g., non-co-located).

In such cases, one or more vCells 210 may be formed (e.g., allocated) each having a different combination of serving cells 205. In some examples, the network entity 105 may form the vCell 210, where, to form the vCell 210, the network entity 105 may select the serving cells 205 and indicate the vCell 210 to the UE 115-a. Alternatively, the network entity 105 may indicate “candidate” serving cells 205 which may be bundled/grouped to form a vCell 210, where the UE 115-a may form the vCell 210 by selecting a set of serving cells 205 from the set of candidate serving cells 205. Accordingly, a complete vCell 210, one either formed by the UE 115-a or the network entity 105, may include serving cells 205 that enable the UE 115-a to access the vCell 210 (e.g., include uplink and downlink serving cells 205). As such, if each step of a RACH procedure could be performed using the serving cells 205 of a vCell 210, then the vCell 210 is complete.

As part of UE-initiated access (e.g., in uplink), the UE 115-a may be aware of the current service metrics and coverage conditions, such that the UE 115-a may select one of the formed vCells 210 accordingly (e.g., select a carrier aggregation combination). Additionally, for downlink, the UE 115-a may utilize a paging procedure to identify and select one of the formed vCells 210.

Accordingly, such service-based access may provide a universal access solution for different tiers of UEs 115. For example, a first tier of UEs 115 may aggregate an increased quantity of serving cells 205 within a vCell 210 (e.g., an increased quantity of bandwidth), while a second tier of UEs 115 may select a single serving cell 205 (e.g., a limited BW) for communications. As such, if a network entity 105 advertises different vCells 210, each including a different quantity of downlink and uplink serving cells 205, each UE 115 can select a vCell 210 according to the service metrics, traffic patterns, coverage conditions, and capabilities, among other examples.

In some aspects, the use of vCells 210 may reduce the latency with which the UE 115-a is able to connect and communicate with the respective serving cells 205 of the vCell 210. That is, the configuration of the SCells in conventional carrier aggregation contexts may increase latency. In particular, in the context of conventional carrier aggregation/multi-cell operation, downlink and uplink SCell configurations may account for a relatively large portion of latency to get the SCells to an operational state. As an illustrative example, the latency associated with downlink SCell configuration latency may account for approximately 43% of the total latency, while the latency for uplink SCell configuration may account for approximately about 83% of the total latency.

For instance, to configure the SCells in conventional downlink carrier aggregation, the UE 115-a may transmit a first RRC message (e.g., RRC Setup Comp) to request the configuration of one or more SCells. In response, the network entity 105 may transmit a second RRC message (e.g., RRC Reconfig) including the carrier aggregation configuration that configures one or more SCells, where the UE 115-a may transmit a third RRC message (e.g., RRC Reconfig Complete) indicating that the UE 115-a has received the carrier aggregation configuration.

In response to receiving the third RRC message, the network entity 105 may transmit a MAC control element (MAC-CE) activating a first SCell of the one or more SCells indicated in the carrier aggregation configuration. Accordingly, the UE 115-a may perform channel measurements on the first SCell and transmit channel state feedback (e.g., channel state information (CSI)) to the network entity 105. If the channel state feedback of the first SCell is sufficient, the network entity 105 may schedule a data (e.g., a physical downlink shared channel (PDSCH) transmission) via the first SCell, such that the UE 115-a may receive the data via the first SCell.

In such cases, however, the UE 115-a may experience an increased configuration delay between the transmission of the first RRC message and the reception of the second RRC message, experience an activation delay between transmission of the third RRC message and reception of the MAC-CE, and experience a scheduling delay between the transmission of the channel state feedback and the reception of the data.

Similarly, to configure the SCells in conventional uplink carrier aggregation, the UE 115-a may transmit a first RRC message (e.g., RRC Setup Comp) to request the configuration of one or more SCells. In response, the network entity 105 may transmit a second RRC message (e.g., RRC Reconfig, event A1) and transmit a third RRC message (e.g., RRC Reconfig) that includes the carrier aggregation configuration that configures one or more SCells.

In response to receiving the carrier aggregation configuration, the UE 115-a may transmit a buffer status report (BSR) indicating a quantity of data to be transmitted from the UE 115-a. Based on receiving the BSR, the network entity 105 may transmit a MAC-CE activating a first SCell of the one or more SCells indicated in the carrier aggregation configuration. The network entity 105 may also transmit resources via which the UE 115-a may transmit the data (e.g., physical uplink shared channel (PUSCH)).

In such cases, however, the UE 115-a may experience an increased configuration delay between the transmission of the first RRC message and the reception of the second and third RRC messages, experience an activation delay between reception of the third RRC message and reception of the MAC-CE, and experience a scheduling delay between reception of MAC-CE and the reception of the resources for the data.

As such, by allowing the UE 115-a to select the vCell 210 (e.g., selecting a combination of serving cells 205), the UE 115-a may experience a reduction to the overall latency. For example, the UE 115-a and the network entity 105 may communicate the measurements and signaling related to SCell configuration in parallel (e.g., via multiple serving cells 205) and as part of cell selection. Accordingly, with access to the vCell 210, the UE 115-a may be ready to communicate (e.g., transmit or receive) via each serving cell 205 within a vCell 210 in response to entering the connected state (e.g., the RRC connected state).

In some cases, the UE 115-a may utilize the vCell 210 during a RACH procedure (e.g., initial access, access procedures) to reduce latency and improve efficiency. For example, the UE 115-a (or the network entity 105) may leverage each serving cell 205 (e.g., each band) of a vCell 210 starting from the RACH procedure, where the UE 115-a may select a vCell 210 that includes serving cells 205 associated with improved uplink communications and include serving cells 205 associated with improved downlink communications.

As an illustrative example, the UE 115-a may transmit uplink messages (e.g., message 1, message 3, or message A) of the RACH procedure using a first set of serving cells 205 of the vCell 210 that are associated with frequency division duplexing (FDD) (e.g., lower frequency bands), while the UE 115-a may receive downlink messages (e.g., message 2, message 4, or message B) of the RACH procedure using a second set of serving cells of the vCell 210 that are associated with time division duplexing (TDD).

In such cases, FDD bands may be more efficient for uplink communications rather than TDD bands due to a smaller subcarrier spacing of FDD bands (e.g., improved coverage areas), due to unrestricted slot formats allowing for lower latency and more efficient repetition handling, and due to increased network energy efficiency while monitoring for the uplink messages (e.g., RACH monitoring in FDD verse TDD), among other examples.

Additionally, in some cases, the FDD bands may be more efficient for uplink communications rather than TDD bands due to the UE 115-a being able to achieve a relatively increased output power in FDD bands relative to TDD bands, which may depend on a transmission chain of the UE 115-a (e.g., 1 power amplifier (PA) associated with 26 dBm gain in FDD vs. two PAs associated with 23 dBm gain each in TDD). Further PAs in relatively higher bands (e.g., TDD bands) may not be efficient. Accordingly, selecting a transmission chain may become increasingly complex for a UE 115 including 4 transmission chains (e.g., 4Tx UEs).

Further, in both uplink and downlink communications, the UE 115-a may benefit from flexibility in selecting the serving cells 205 of the vCell 210, which may reduce complexity of radio frequency management, affect placement of antennas and managing exposure, and affect the total power considerations for uplink communications. For example, because power class is defined as the aggregated power across serving cells 205 (e.g., sub-bands or bands), the UE 115-a may decide which bands to aggregate to be able to more efficiently handle exposures (e.g., maximum permissible exposures (MPEs) or Specific Absorption Rate).

In some wireless communications systems 200, such as 6G communication systems, the UE 115-a may be permitted to access the vCell 210 as part of a cell selection procedure and also a cell re-selection procedure. In such examples, if the vCell 210 includes multiple serving cells 205, as illustrated in FIG. 2, each serving cell 205 may be associated with respective uplink configurations (e.g., UplinkConfigCommonSIBs), with respective downlink configurations (e.g., DownlinkConfigCommonSIBs), or both. As an illustrative example, the initial downlink and uplink bandwidth parts for each serving cell 205 within the vCell 210 may be different.

Further, the resources for performing each RACH step of a RACH procedure may be associated with (e.g., in) different serving cells 205 of the vCell 210. That is, each serving cell 205 may be associated with a respective set of RACH resources, where each set of RACH resources is for a specific step of the RACH procedure. In such cases, however, current 5G RACH procedures may not enable the UE 115-a to access the vCell 210, nor do current 5G RACH procedures enable the UE 115-a to perform RACH procedures across multiple serving cells to access the multiple serving cells 205 of a vCell.

For example, if the serving cells 205 of the vCell 210 are non-collocated, it may be desirable for the UE 115-a may perform the RACH procedure via a single serving cell 205, thereby reducing complexity within the wireless communications system 200. In such cases, however, if the UE 115-a performs the RACH procedure via a single serving cell 205, the network entity 105 may not have an indication of the situation of the UE 115-a on the other serving cells 205 prior to the connection. That is, by performing the RACH procedure via a single serving cell 205, current signaling techniques may not provide the network entity 105 information on how the UE 115-a selected the other serving cells 205 of the vCell 210, information on which beam(s) the UE 115-a selected for one or more serving cells 205, nor an indication of whether the UE 115-a is accessing the single serving cell 205 or the vCell 210 as a whole.

Alternatively, as part of load balancing for each of the serving cells 205 of the vCell 210 at the network entity 105, it may be desirable for the UE 115-a to perform the RACH procedure via multiple serving cells 205 of the vCell 210. In such cases, however, if the UE 115-a performs the RACH procedure via multiple serving cells 205 and transmits a message 215 (e.g., PRACH, message 1, message A) via a first beam of the serving cell 205-b, the network entity 105 may not have an indication of which beam of the serving cell 205-c to use for the transmission of a message 220 (e.g., random access response (RAR), message 2, message B). Thus, techniques may be desired to enable the UE 115-a to perform the RACH procedure to access the vCell 210.

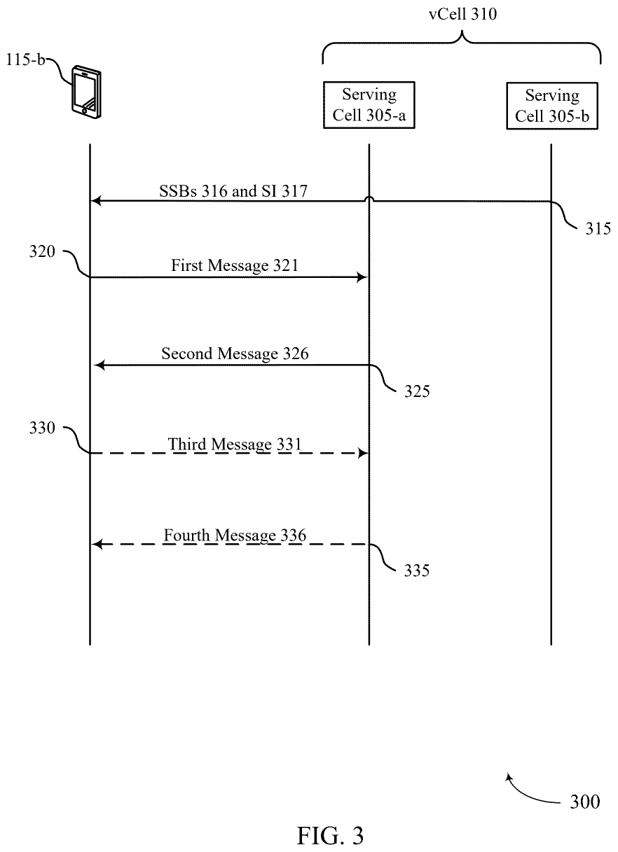

The techniques described herein provide for signaling techniques that enable the UE 115-a to access the vCell 210 via one or more multiple serving cells 205 of the vCell 210 according to the deployment (e.g., configuration) of the vCell 210 and load of the network. In some examples, the UE 115-a may perform the RACH procedure to access the vCell 210 via a single serving cell 205 of the vCell 210. For example, the UE 115-a may transmit a message 215 (e.g., message 1 or message A) to the vCell 210 via the serving cell 205-b. In response, the UE 115-a may receive a message 220 (e.g., message 2 or message B) from the vCell 210 via the serving cell 205-b. Based on successful performance of the RACH procedure, the UE 115-a may communicate the data 225 with the serving cells 205 of the vCell 210. Techniques to access a vCell 210 via a single serving cell 205 may be further described herein with reference to FIG. 3.

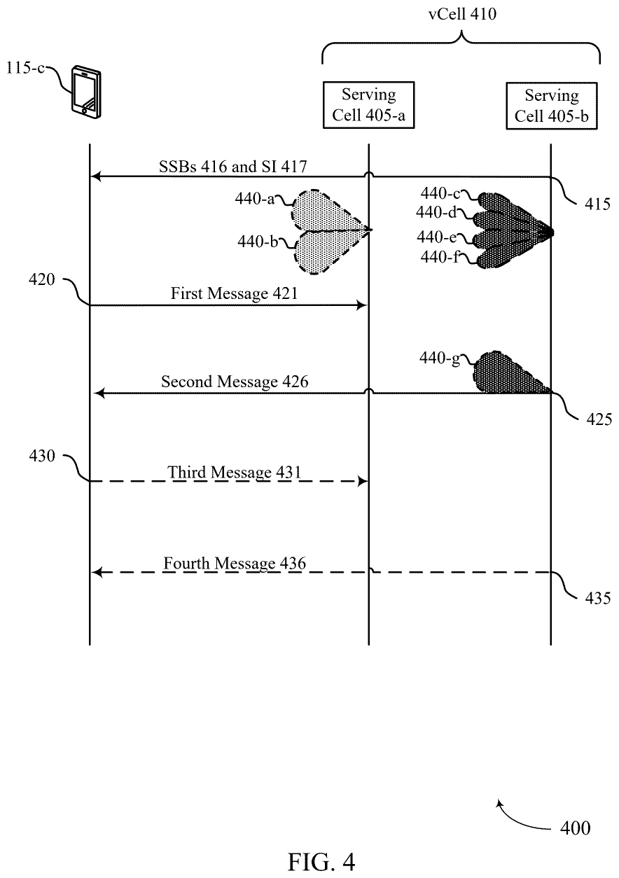

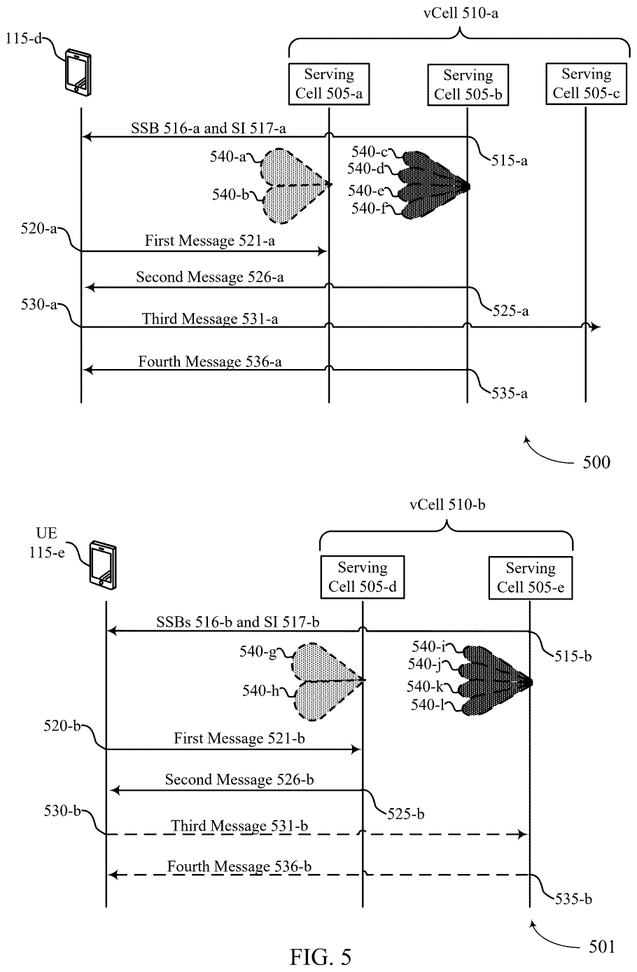

In some other examples, the UE 115-a may perform the RACH procedure to access the vCell 210 via multiple serving cells 205 of the vCell 210. For example, the UE 115-a may transmit the message 215 via the serving cell 205-c. In response, the UE 115-a may receive the message 220 via the serving cell 205-e. Based on successful performance of the RACH procedure, the UE 115-a may communicate the data 225 with the serving cells 205 of the vCell 210. Techniques to access a vCell 210 via multiple serving cells 205 may be further described herein with reference to FIGS. 4 and 5.

FIG. 3 shows an example of a process flow 300 that supports random-access procedures to access vCells in wireless communications systems in accordance with one or more aspects of the present disclosure. Aspects of the process flow 300 may implement, or be implemented by, aspects of the wireless communications system 100 and the wireless communications system 200. For example, the process flow 300 may be implemented by a UE 115-b, which may be an example of a UE 115 as described herein. The process flow 300 may also be implemented by a vCell 310, including a serving cell 305-a and a serving cell 305-b. Although illustrated as including two serving cells 305, it should be understood that the vCell 310 may include any quantity of serving cells 305. The techniques described in the context of the process flow 300 may enable the UE 115-b to perform a RACH procedure to access the vCell 310 via a single serving cell 305 (e.g., via the serving cell 305-a), which may enable the UE 115-b to perform RACH on the vCell 310 using the RACH steps of the 5G framework.

At RACH procedure step 315, the UE 115-b may receive one or more synchronization signal blocks (SSBs) 316 and SI 317 associated with the vCell 310. In such examples, the UE 115-b may receive the SSBs 316 and the SI 317 from the serving cell 305-b. In other examples, the UE 115-b may receive the SSBs 316 and the SI 317 from the serving cell 305-a, or receive the SSBs 316 from the serving cell 305-b and receive the SI 317 from the serving cell 305-a, or vice versa. In such examples, the SI 317 may indicate for the UE 115-b to perform the two-step RACH procedure via a single serving cell 305, such as the serving cell 305-a.

In some examples, the UE 115-b may perform a two-step RACH procedure to access the vCell 310 via the serving cell 305-a. For example, the UE 115-b may transmit, via the serving cell 305-a, the first message 321 (e.g., message A) according to the SI 317 to access the vCell 310 at RACH procedure step 320. In response, at RACH procedure step 325, the UE 115-b may receive, via the serving cell 305-a, a second message 326 (e.g., message B) to complete the two-step RACH procedure.

In some other examples, the UE 115-b may perform a four-step RACH procedure to access the vCell 310 via the serving cell 305-a. For example, the UE 115-b may transmit, via the serving cell 305-a, the first message 321 (e.g., message 1) according to the SI 317 to access the vCell 310 at the RACH procedure step 320. In response, the UE 115-b may receive, via the serving cell 305-a, the second message 326 (e.g., RAR, message 2). According to the second message 326, the UE 115-b may transmit, via the serving cell 305-a, the third message 331 (e.g., message 3) at the RACH procedure step 330, where, in response, the UE 115-b may receive the fourth message 336 via the serving cell 305-a at RACH procedure step 335, thereby completing the four-step RACH procedure.

To facilitate such two and four step RACH procedures, a network entity 105 scheduling the vCell 310 may configure, via the SI 317, the UE 115-b to perform the RACH procedure via a single serving cell 305. For example, the SI may include an indication of RACH resources to use for the RACH procedure, where such RACH resources may be associated with (e.g., mapped to, correspond to) the serving cell 305-a. Thus, as described herein, the UE 115-b may communicate each RACH message (e.g., first message 321, second message 326, third message 331, and fourth message 336) via the RACH resources indicated via the SI 317.

In some examples, the network entity 105 may dedicate (e.g., allocate) different RACH resources for accessing the vCell, such that the UE 115-a may transmit the first message 321 to indicate to the network entity 105 that the UE 115-b is to connect to the vCell 310. That is, the UE 115-b may receive a first SI from the serving cell 305-a, where the first SI indicates a first set of RACH resources for accessing the serving cell 305-a independently and separately from the vCell 310. In such cases, the UE 115-a may use separate sets of RACH resources depending on whether the UE 115-a intends to access a cell individually, or as part of the vCell. Accordingly, the SI 317 may indicate a second set of RACH resources different from the first set of RACH resources, such that if the UE 115-a transmits the first message 321 (e.g., message 1 or message A) via the second set of RACH resources, the network entity 105 may have an indication that the UE 115-b is to access the vCell 310.

In some other examples, if the UE 115-b is not configured with separate RACH resources for connecting to the serving cell 305-a and connecting to the vCell 310 via the SI 317 (e.g., the UE 115-b receives a single set of RACH resources for a RACH procedure), the UE 115-a may include an indication in the first message 321, the third message 331, or both, that the UE is to connect to the vCell 310. For example, the UE 115-b may receive, via the SI 317, an indication of RACH resources for performing the RACH procedure, where the RACH resources may be associated with the serving cell 305-a. Accordingly, to differentiate between accessing the vCell 310 or accessing the serving cell 305-a independently, the UE 115-b may include an indication in the first message 321, the third message 331, or both, as to whether the UE 115-b is to connect to the vCell or the serving cell 305-a independently.

In some examples, multiple vCells 310 may be formed, where each vCell 310 includes multiple serving cells 305. Accordingly, each vCell 310 may be associated with a respective set of RACH resources, such that the respective set of RACH resources for a first vCell 310 may not overlap with a respective set of RACH resources for a second vCell 310. In such examples, the SI 317 for each vCell 310 may indicate the respective RACH resources for the corresponding vCell 310. Accordingly, by transmitting the first message 321 on the set of RACH resources associated with the vCell 310, the UE 115-b may indicate that the UE 115-b is to connect with the vCell 310, rather than another vCell 310.

In some other wireless networks, such as 5G networks, if the UE 115-b selects a cell, the network entity 105 operating the cell may have an information about the UE 115-b prior to configuring the UE 115-b via RRC signaling. For example, in the other wireless networks, after cell selection, the network entity 105 may have an indication of which beams the UE 115-b has selected to use for connection with the cell. Due to obtaining such information, the network entity 105 may refrain from configuring, via RRC signaling, all possible transmission configuration indicator (TCI) states or CSI reference signal (CSI-RS) resources while the UE 115-b is operating in the connected mode. That is, by having an indication of which SSB beam the UE 115-b has selected at cell selection, the network entity 105 may indicate relatively fewer beam parameters (e.g., configurations) in the vicinity of the selected beam.

However, in the example of RACH procedures for a vCell 310 using a single serving cell 305, the network entity 105 may not have any information from the UE 115-b regarding beam selection for other serving cells 305 of the vCell 310, such as the serving cell 305-b.

Accordingly, to provide such beam information, the UE 115-b may transmit an L1 report (not shown) associated with the serving cells 305 of the vCell 310 on which the UE 115-b is performing the RACH procedure, where the UE 115-b may transmit the L1 report prior to RRC connection establishment (e.g., prior to security establishment). For example, the UE 115-b may transmit the L1 report prior to, subsequent to, or in conjunction with transmitting the third message 331. In such examples, the L1 report may not be secured. However, in some wireless networks (e.g., 5G networks), there may be scenarios in which the UE 115-b is allowed to transmit the L1 report prior to the security establishment, such as in lower layer triggered mobility (LTM). Additionally, wireless networks, such as 6G networks, may provide enhancements on securing the L1 report, which may be applied to the transmission of the L1 report.

The UE 115-b may include, within the L1 report, beam information associated with one or more serving cells 305 of the vCell 310. For example, the UE 115-b may include, within the L1 report, multiple beam indices (e.g., first K strongest beam indices) for each serving cell 305 of the vCell 310, where each beam index of the multiple beam indices satisfies a performance metric (e.g., RSRP, reference signal received quality (RSRQ), signal interference and noise ratio (SINR), among other examples). Further, a quantity of the multiple beam indices reported for each serving cell 305 may satisfy a threshold quantity of beam indices (e.g., K), where the threshold quantity of beam indices may be indicated via the SI 317 or the second message 326. In some other examples, the UE 115-b may include, within the L1 report, a performance metric (e.g., RSRP, RSRQ, SINR) of each serving cell 305 of the vCell 310. Accordingly, the network entity 105 may utilize the information received via the L1 report to configure the vCell more efficiently.

In some examples, the UE 115-b may connect with a subset of the serving cells 305 of the vCell 310, for example, in scenarios where the UE 115-b determines with which serving cells 305 to connect (e.g., network-specific vCells 310) or in scenarios where the UE 115-b forms the vCell (e.g., UE-specific vCells 310). In such examples, the UE 115-b may also indicate, via the L1 report, a subset of the serving cells 305 of the vCell 310 the UE 115-b is to connect with.

To indicate the subset of the serving cells 305, the UE 115-b may include, in the L1 report, the identity of the subset of serving cells 305 with which the UE is to connect. In some examples, the UE 115-b may include a bitmap within the L1 report, where each bit of the bitmap is associated with a serving cell 305 of the vCell 310. In this way, the UE 115-b may set the bits associated with the subset of the serving cells 305 to a ‘1’ (or ‘0’).

In some other examples, to indicate the subset of the serving cells 305, the UE 115-b may include a list of serving cells 305 within the L1 report, where the list may include an identifier (ID) of the serving cells 305 with which the UE 115-b is to connect. In some other examples, to indicate the subset of the serving cells 305, the UE 115-b may include, within the L1 report, the beam information for the subset of the serving cells 305 with which the UE 115-b is to connect and refrain from including the beam information for a remaining subset of the serving cells 305.

To transmit the L1 report, the UE 115-b may use a set of resources indicated by the network, where such resources may be mapped to (e.g., correspond to or be associated with) the serving cell 305-a (e.g., the serving cell 305 with which the UE 115-b is performing the RACH procedure) or the serving cell 305-b. For example, the UE 115-b may receive, via the SI 317, the set of resources for transmitting the L1 report. Alternatively, the UE 115-b may receive the set of resources via the second message 326 (e.g., message 2 or message B) or the fourth message 336.

In some examples, to choose which serving cells 305 of the vCell 310 and beams of such serving cells 305 with which to communicate prior to connection, the UE 115-b may communicate such information to the network entity 105 after successfully performing the RACH operation to connect with the vCell 310 via the serving cell 305-a. For example, after successfully performing contention resolution via the serving cell 305-a (e.g., after receiving second message 326 in the two-step RACH or after receiving the fourth message 336 in the four-step RACH), the UE 115-b may receive dedicated RACH resources associated with the serving cell 305-b (e.g., another serving cell 305) of the vCell 310. Accordingly, the UE 115-b may transmit the first message 321 (e.g., PRACH) via the RACH resources, where the UE 115-b may indicate a subset of the serving cells 305 of the vCell 310 with which the UE 115-b is to connect, indicate the selected beams for each of the subset of serving cells 305, or both via the first message 321.

As an illustrative example, after connecting to the vCell 310 via the serving cell 305-a, the UE 115-b may receive RACH resources associated with the serving cell 305-b. Accordingly, the UE 115-b may transmit the first message 321 via the RACH resources associated with the serving cell 305-b, where the UE 115-b may indicate that the UE 115-b is connect to the serving cell 305-a and refrain from connecting with the serving cell 305-b of the vCell 310. Additionally, the UE 115-b may indicate the beams associated with the serving cell 305-a via which the UE 115-b is to communicate.

As described herein, the techniques described in the context of the process flow 300 may enable the UE 115-b to efficiently access the vCell 310 via a single serving cell 305. However, such techniques may not address various ambiguities caused by RACH splitting across multiple serving cells 305. For example, the vCell 310 may include the serving cell 305-a and the serving cell 305-b, where the serving cell 305-a may operate two beams and receives uplink RACH messages, while the serving cell 305-b may operate the four beams and transmit downlink RACH messages. In such examples, the UE 115-b may perform the split RACH procedure due to a different between uplink and downlink coverages of the serving cells 305, where the serving cell 305-a may be associated with FDD with improved uplink coverage, while the serving cell 305-b may be associated with TDD with improved or similar downlink coverage.

Accordingly, if the UE 115-b sends the first message 321 on a first beam of the serving cell 305-a, the serving cell 305-b may not have an indication of which beam the second message 326 should be transmitted. That is, the signaling techniques of the process flow 300 may not be sufficient for RACH splitting. Techniques to perform such RACH splitting may be further described with reference to FIGS. 4 and 5.

FIG. 4 shows an example of a process flow 400 that supports random-access procedures to access vCells in wireless communications systems in accordance with one or more aspects of the present disclosure. Aspects of the process flow 400 may implement, or be implemented by, aspects of the wireless communications system 100, the wireless communications system 200, and the process flow 300. For example, the process flow 400 may be implemented by a UE 115-c, which may be examples of the UEs 115 described herein. Additionally, the process flow 400 may be implemented by a serving cell 405-a and a serving cell 405-b grouped together in the vCell 410, which may be examples of corresponding entities as described herein. Although illustrated as including two serving cells 405, it should be understood that the vCell 410 may include any quantity of serving cells 405. The techniques described in the context of the process flow 400 may enable the UE 115-c to perform a RACH procedure to connect with the vCell 410 using multiple serving cells 405.

At RACH procedure step 415, the UE 115-c may receive one or more SSBs 416 and SI 417 associated with the vCell 410. In such examples, the UE 115-c may receive the SSBs 416 and the SI 417 from the serving cell 405-b. In other examples, the UE 115-c may receive the SSBs 416 and the SI 417 from the serving cell 405-a, or receive the SSBs 416 from the serving cell 405-b and receive the SI 417 from the serving cell 405-a, or vice versa. In such examples, the SI 417 may indicate for the UE 115-c to perform the two-step RACH procedure via multiple serving cells 405, such as the serving cell 405-a and the serving cell 405-b. As illustrated in the process flow 400, the SI 417 may indicate for the UE 115-c to transmit uplink RACH messages (e.g., a first message 421 and/or a third message 431) via the serving cell 405-a and receive downlink RACH messages (e.g., the second message 426 and/or the fourth message 436) via the serving cell 405-b.

In some examples, the UE 115-c may perform a two-step RACH procedure to access the vCell 410. For example, the UE 115-c may transmit, via the serving cell 405-a, the first message 421 (e.g., message A) according to the SI 417 to access the vCell 410 at RACH procedure step 420. In response, at RACH procedure step 425, the UE 115-c may receive, via the serving cell 405-b, a second message 426 (e.g., message B) according to the SI 417, thereby completing the two-step RACH procedure.

In some other examples, the UE 115-c may perform a four-step RACH procedure to access the vCell 410. For example, the UE 115-c may transmit, via the serving cell 405-a, the first message 421 (e.g., message 1) according to the SI 417 to access the vCell 410 at the RACH procedure step 420. In response, the UE 115-c may receive, via the serving cell 405-b, the second message 426 (e.g., RAR, message 2) according to the SI 417. According to the second message 426, the UE 115-c may transmit, via the serving cell 405-a, the third message 431 (e.g., message 4) at the RACH procedure step 430, where, in response, the UE 115-c may receive the fourth message 436 via the serving cell 405-b at RACH procedure step 435, thereby completing the four-step RACH procedure.

As illustrated, the serving cell 405-a may operate the beams 440-a and 440-b and be configured, via the SI 417, receive the uplink RACH messages (e.g., first message 421 and third message 431), while the serving cell 405-b may operate the beams 440-c, 440-d, 440-e, and 440-f and be configured, via the SI 417, to transmit the downlink RACH messages (e.g., second message 426 and the fourth message 436). As described herein, the serving cell 405-a may be associated with an FDD band, while the serving cell 405-b may be associated with a TDD band.

To facilitate such RACH procedures across multiple serving cells 405, the network entity 105 may indicate, via the SI 417, which beams 440 map across the constituent serving cells 405, where such mappings may apply to the vCell RACH resources (in which the UE performs the RACH procedure) and apply to transmission of an L1 report (described herein with reference to FIG. 3). That is, the UE 115-b may receive, via the SI 417, a mapping between the beams 440 of the serving cell 405-a and the beams 440 of the serving cell 405-b, such that the vCell 410 and the UE 115-b may coordinate on which beams 440 to perform the RACH procedure.

For example, the network entity 105 scheduling the vCell 410, may map the beam 440-a of the serving cell 405-a to the beams 440-c and 440-d of the serving cell 405-b and also map the beam 440-b of the serving cell 405-a to the beams 440-e and 440-f of the serving cell 405-b. As such, the UE 115-b may receive such mappings via the SI 417. As another example, if the vCell 410 includes a third serving cell 405 (not shown) that includes a first beam and a second beam for downlink RACH messages, the network entity 105 may map the beam 440-a to the beam 440-c of the serving cell 405-b and to the first beam of the third serving cell 405. In this way, the network entity 105 may map the uplink beams 440 and downlink beams 440 across multiple serving cells 405 of the vCell 410.

Further, given the mappings between the beams of the serving cells 405 of the vCell 410 and the RACH splitting between the uplink and downlink directions across the serving cells 405, the network entity 105 may also indicate, via the SI 417, one or more cases associated with monitoring the beams 440 from the serving cell 405-b.

In a first case, the UE 115-c expects to receive the downlink RACH messages on either one of the downlink beams 440 (e.g., monitors each beam 440 in the mapping). As an illustrative example of the first case, if the UE 115-c transmits the first message 421 via the beam 440-a of the serving cell 405-a, the UE 115-c may have an indication that the second message 426 is to be received via the beams 440-c and/or 440-d based on the mapping provided in the SI 417. As such, if the SI 417 also indicates that the UE 115-c is to operate according to the first case, the UE 115-c may monitor both the beam 440-c and beam 440-d to receive the second message 426. In such examples, the serving cell 405-b (e.g., network) may transmit the second message 426 on one or both of the beams 440-c and 440-d.

In a second case, the UE 115-c expects to receive the downlink RACH messages on any of the downlink beams 440 (e.g., monitors a single beam 440 in the mapping). As an illustrative example of the second case, if the UE 115-c transmits the first message 421 via the beam 440-a of the serving cell 405-a, the UE 115-c may have an indication that the second message 426 is to be received via the beams 440-c and/or 440-d based on the mapping provided in the SI 417. As such, if the SI 417 also indicates that the UE 115-c is to operate according to the second case, the UE 115-c may monitor either the beam 440-c or beam 440-d to receive the second message 426 due to the serving cell 405-b transmitting the second message 426 on both the beams 440-c and 440-d.

In some examples, if the UE 115-c is provided a mapping in the SI 417 between the beam 440-a and all the downlink beams 440 of the serving cells 405 of the vCell 410, then the serving cells 405 may repeat the downlink RACH messages on each downlink beam 440, such that the UE 115-c may monitor a single downlink beam 440. As an illustrative example, if the beam 440-a is mapped to the beams 440-c, 440-d, 440-d, and 440-f, then the serving cell 405-b may repeat the downlink RACH messages on each of the beams 440, such that the UE 115-c may monitor anyone of the beams 440 of the serving cell 405-b.

In some other examples, if the UE 115-c is provided a mapping in the SI 417 between the beam 440-a and all the downlink beams 440 of the serving cells 405 of the vCell 410, then the UE 115-c may monitor for the downlink RACH messages on each of the beams 440 of the serving cells 405 (e.g., on all the beams of other serving cells 405). As an illustrative example, if the beam 440-a is mapped to the beams 440-c, 440-d, 440-d, and 440-f, then the serving cell 405-b may transmit the downlink RACH message on a single beam 440, such that the UE 115-c may monitor each of the beams 440 of the serving cell 405-b.

In some examples, for accessing a vCell 410 with RACH split across the constituent serving cells 405, the serving cell 405-b may mimic the beam 440 of the serving cell 405-a (e.g., the uplink serving cell 405) for the downlink RACH messages until reception of beam information from the UE 115-c, where such beam information may be provided by the L1 report or after successful contention resolution as described herein with reference to FIG. 3. As such, the UE 115-c may expect to receive the downlink RACH messages from the serving cell 405-b via a similar beam 440 as the beam 440 used to transmit the uplink RACH messages.

For example, the UE 115-c may transmit the first message 421 via the beam 440-a of the serving cell 405-a. Accordingly, the serving cell 405-b may mimic the beam characteristics (e.g., beam direction, beam width, among other examples) of the beam 440-a to transmit the second message 426 until the UE 115-b transmits the beam information about which beam(s) 440 of the serving cell 405-b the UE 115-c has chosen. As such, the serving cell 405-b may transmit the second message 426 and/or the fourth message 436 via the beam 440-g, where the beam 440-g may have the same or similar beam characteristics as the beam 440-a.

In some examples, due to reflection or blockage, the indicated beam mappings across the serving cells 405 of the vCell 410 may not be suitable for the UE 115-c. In such examples, a timer may be defined, where, upon expiration, the UE 115-c may start monitoring for the downlink RACH messages on each beam 440 of the serving cell 405-b, rather than the beams 440 indicated by the mapping. In such examples, the timer may be predefined or indicated via the SI 417. Such a timer may be distinct from the RAR monitoring window (indicated via ra-ResponseWindow in the RACh-ConfigGeneric information element), where the RAR monitoring window may be for monitoring the second message 426 on a chosen beam of a cell in that window.

As an illustrative example, the UE 115-c may receive an indication that the beam 440-a is mapped to the beams 440-c and 440-d. Additionally, the timer may be set at 10 ms (e.g., indicated via the SI 417 or predefined). Accordingly, after transmitting the first message 421 via the beam 440-a of the serving cell 405-a, the UE 115-c may monitor the beam 440-c and/or the beam 440-d for reception of the second message 426. As such, if the UE 115-c does not detect and receive the second message 426 on the beams 440-c and 440-d after expiration of the timer (e.g., after 10 ms), the UE 115-c may begin monitoring be beams 440-c, 440-d, 440-e, and 440-f for reception of the second message 426. Similarly, after expiration of the timer, the serving cell 405-b may begin transmitting the second message 426 via each beam 440 of the serving cell 405-b.

To provide further fallback mechanisms to ensure reception of the downlink RACH messages, the UE 115-c may receive, via the SI 417, an indication of reserved RACH resources for other serving cells 405 of the vCell 410 for transmission of the downlink RACH messages. That is, the network entity 105 may allocate multiple sets of RACH resources, each associated with a respective serving cell 405 of the vCell 410, such that if the UE 115-c fails to receive the downlink RACH messages on a first set of downlink RACH resources associated with a first serving cell 405, the UE 115-c may monitor a second set of downlink RACH resources associated with a second serving cell 405 for the downlink RACH messages.

In such examples, a respective timer may be indicated for each set of downlink RACH resources (e.g., for each serving cell 405), such that after expiration of the respective timer and failure to receive the downlink RACH message, the UE 115-c may switch to monitoring a different set of RACH resources.

Each set of RACH resources (e.g., each serving cell 405) may be associated with a priority, which may indicate to the UE 115-c in which order the UE 115-c is to monitor the downlink RACH resources. In such examples, the priority between each set of RACH resources may be indicated explicitly, or implicitly, by the order of the set of RACH resources in the SI 417. For example, each set of RACH resources may be associated with a respective ID, such that the ID may explicitly indicate the priority of each set of RACH resources, thereby enabling the UE to know which set of downlink RACH messages to start monitoring if the previous set of RACH resources fails. Similarly, the order of the set of RACH resources may be implicitly indicated according to the order of the set of RACH resources in the SI 417.

As an illustrative example, the UE 115-c may receive, via the SI 417, an indication of a first set of downlink RACH resources associated with the serving cell 405-b and a second set of downlink RACH resources associated with the serving cell 405-a, where the first set of downlink RACH resources may have a higher priority than the second set of downlink RACH resources. Further, the SI 417 may indicate a first timer associated with the first set of downlink RACH resources and indicate a second timer associated with the second set of downlink RACH resources.

Accordingly, the UE 115-c may initially monitor for the second message 426 via the first set of downlink RACH resources for the duration of the first timer. As such, based on expiration of the first timer and failure to receive the second message 426, the UE 115-c may switch to monitoring the second set of RACH resources for the duration of the second timer.

In some examples, the UE 115-c may not receive the downlink RACH messages (e.g., second message 426 and/or the fourth message 436) via the serving cell 405-b due to the network entity 105 not obtaining the first message 421 via the serving cell 405-a. As such, to reduce the likelihood that the first message 421 is not successfully transmitted, the UE 115-c may receive, via the SI 417, multiple sets of uplink RACH resources for transmission of the first message 421 (e.g., message 1, PRACH, message A), where each set of uplink RACH resources may be associated with a respective serving cell 405. Accordingly, the UE 115-c may select a set of RACH resources from among the indicated sets of uplink RACH resources to increase the possibility of success.

In such examples, the UE 115-c may randomly select a set of uplink RACH resources from among the multiple sets of uplink RACH resources to transmit the first message 421. In some other examples, the UE 115-c may receive, via SI 417, a probability threshold for one or more of the multiple sets of uplink RACH resources in order to prioritize the multiple sets of RACH resources. As an illustrative example, the UE 115-c may receive, via the SI 417, a first set of uplink RACH resources associated with the serving cell 405-a and a second set of uplink RACH resources associated with the serving cell 405-b. The UE 115-b may also receive an indication of a threshold probability (e.g., X). Accordingly, the UE 115-b may generate a random number, such that if the random number is greater than the probability threshold, the UE 115-b transmits the first message 421 via the first set of uplink RACH resources, otherwise the UE 115-c may transmit the first message 421 via the second set of uplink RACH resources.

In some examples, the network entity 105 may also indicate additional uplink RACH resources for transmission of the first message 421 across the serving cells 405 of the vCell 410, where the UE 115-b may utilize a selection rule (e.g., predefined or indicated via the SI 417) to select one of the additional uplink RACH resources. That is, the UE 115-b may receive an indication of one or more sets of uplink RACH resources used for fallback scenarios (e.g., scenarios in which the first message 421 is not successfully received). In such examples, each of the one or more sets of uplink RACH resources may be associated with a timer and a priority, such that the UE 115-c may switch between each of the one or more sets of uplink RACH resources, as described herein with reference to the downlink RACH resources.

As described herein, for the vCell 410 with RACH splitting across its constituent serving cells 405, the network entity 105 may group beams 440 across the serving cells 405 in different combinations. As such, for each combination, the network entity 105 may also provide an uplink RACH resource for transmission of the first message 421. In this way, the UE 115-a may indicate which beam combination according to transmission of the first message 421.

As an illustrative example, the network entity 105 scheduling the vCell 410, may indicate, via the SI 417, a first mapping between the beam 440-a of the serving cell 405-a and the beams 440-c and 440-d of the serving cell 405-b and also indicate a second mapping between the beam 440-b of the serving cell 405-a and the beams 440-e and 440-f of the serving cell 405-b. Further, the network entity 105 may allocate a first set of uplink RACH resources to be associated with the first mapping and a second set of uplink RACH resources to be associated with the second mapping, where both the first and second set of uplink RACH resources may be associated with different portions of a CC operated by the serving cell 405-a.

As such, if the UE 115-c transmits the first message 421 via the first set of RACH resources, the network entity 105 may have an indication that the UE 115-c has selected the first mapping. Similarly, if the UE 115-c transmits the first message 421 via the second set of RACH resources, the network entity 105 may have an indication that the UE 115-c has selected the second mapping

In such examples, if the network entity 105 groups single beams 440 across the serving cell 405 (e.g., one to one mappings), the network entity 105 may allocate an increased quantity of uplink RACH resources (e.g., 8 RACH resources on the serving cell 405-a) in order for the UE 115-c to indicate which beam combinations have been selected. As such, providing such an increased quantity of uplink RACH resources may scale drastically by the quantity of beams 440 and a quantity of serving cells 405 of the vCell 410.

In a 5G wireless network, the beams of the SSBs 416 a cell may be mapped to RACH resources (e.g., RACH occasions) of the same cell. In such cases, however, a vCell 410 may be constructed by multiple serving cells 405, where a single serving cell 405 of the vCell 410 is operating multiple beams 440. For example, the serving cell 405-a may operate a single beam 440 (e.g., in a low-band), such as the beam 440-a, while the serving cell 405-b operates multiple beams 440 (e.g., in a TDD band).

In such examples, for the vCell 410 including multiple serving cells 405, where a single serving cell 405 is operating via h multiple beams 440, with multiple SBs/cells/CCs where only one of them is operating via multiple beams, the network entity 105 may indicate, via the SI 417, for the UE 115-c to perform the RACH procedure according to a current 5G RACH framework in order to indicate the RACH resources, where the RACH resources for the vCell 10 may be mapped to beams 440 of the multi-beam serving cell 405. As an illustrative example, the RACH resources associated with the serving cell 405-a may be mapped to the beams 440 of the serving cell 405-b, where such a mapping may be indicated via the SI 417.

FIG. 5 shows an example of a process flow 500 and a process flow 501 that support random-access procedures to access vCells in wireless communications systems in accordance with one or more aspects of the present disclosure. Aspects of the process flow 500 and the process flow 501 may implement, or be implemented by, aspects of the wireless communications system 100, the wireless communications system 200, the process flow 300, and the process flow 400.

With respect to the process flow 500, the process flow 500 may include a vCell 510-a that includes a serving cell 505-a, a serving cell 505-b, and a serving cell 505-c, which may be examples of corresponding entities as described herein. Additionally, the process flow 500 may implement a UE 115-d, which may be an example of the UEs 115 as described herein. The techniques described in the context of the process flow 500 may enable the UE 115-d to perform the RACH procedure across multiple serving cells 505 of the vCell 510-a.

For example, the process flow 500 may illustrate a four-step RACH procedure, where at the RACH procedure step 515-a, the UE 115-d may receive the SSBs 516-a and the SI 517-a, which may be an example of the SIs described herein with reference to FIGS. 3 and 4. In such examples, the SI 517-a may indicate for the UE 115-d to transmit the first message 521-a (e.g., message 1) to the serving cell 505-a at the RACH procedure step 520-a, indicate for the UE 115-d to receive the second message 526-a (e.g., RAR or message 2) and the fourth message 536-a (e.g., message 4) from the serving cell 505-b at the at the RACH step 525-a and 535-a, respective, and transmit the third message 531-a (e.g., message 3) to the serving cell 505-c at the RACH step 530-a.

In such examples, the network entity 105 scheduling the vCell 510-a may implement such a RACH split in cases where the serving cell 505-a may not have sufficient uplink resources to support the reception of the third message 531-a and where the serving cell 505-b may allocated for downlink communications.

Accordingly, as described herein with reference to FIG. 4, the SI 517-a may indicate a mapping between the beams 540 (e.g., beams 540-a and 540-b) of the serving cell 505-a, the beams 540 (e.g., beams 540-c, 540-d, 540-e, and 540-f) of the serving cell 505-b, and the beams 540 (not shown) of the serving cell 505-c. Additionally, as described herein with reference to FIG. 4, if the SI 517-a indicates the first monitoring case (e.g., the UE 115-c monitors each downlink beam 540 for reception of the downlink RACH messages), then the UE 115-d may repeat the third message 531-a on multiple beams 540 of the serving cell 505-c. In such cases, however, because the second message 526-a (e.g., RAR) in 5G wireless networks supports granting a single uplink resource for transmission of the third message 531-a, current signaling techniques may be unable support such RACH splitting.

Accordingly, if the UE 115-d is to repeat the third message 531-a on multiple beams 540 of the serving cell 505-c, the UE 115-d may receive, via the second message 526-a, a respective RACH resources on each of the serving cells 505 indicated in the received mapping, thereby enabling the UE 115-d to transmit repetitions of the third message 531-a on respective RACH resources according to the grant received via the second message 526-a.

As an illustrative example, if the UE 115-d is to repeat the third message 531-a on two beams 540 of the serving cell 505-c, according to the mapping between beams 540 of the serving cells 505 received via the SI 517-a, then the UE 115-d may receive two RACH resources, one for each beam 540 of the serving cell 505-c, to transmit the repetitions of the third message 531-a.

With respect to the process flow 501, the process flow 501 may include a vCell 510-b that includes a serving cell 505-d and a serving cell 505-e, which may be examples of corresponding entities as described herein. The process flow 501 may also include a UE 115-e, which may be an example of the UEs 115 as described herein. The techniques described in the context of the process flow 501 may enable the UE 115-e to perform the RACH procedure across multiple serving cells 505 of the vCell 510-b.

The process flows 400 and 500 may illustrate RACH procedures split according to communication direction (e.g., downlink RACH messages on a first serving cell 505 and uplink RACH messages on a second serving cell 505). However, the network entity 105 may split such RACH procedures according to RACH steps, as illustrated in the process flow 501.

That is, the process flow 501 may illustrate a four-step RACH procedure, in which the RACH procedure may be split according to the RACH steps. For example, at RACH procedure step 515-b, the UE 115-e may receive SSBs 516-b and SI 517-b, where the SI 517-b may indicate that the UE 115-e is perform the RACH step procedures 520-b (e.g., transmit the first message 521-b) and 525-b (e.g., receive the second message 526-b) via the serving cell 505-d and perform the RACH steps 530-b (e.g., transmit the third message 531-b) and 535-b (e.g., receive the fourth message 536-b) via the serving cell 505-e.

In such examples, however, the network entity 105 may not have an indication of which beam 540 of the serving cell 505-d is selected by the UE 115-e, such that the network entity 105 may be unable to grant the correct uplink RACH resources for the transmission of the third message 531-b (e.g., within the second message 526-b).

Accordingly, the network entity 105 may indicate, via the SI 517-b, a mapping between the beams 540 of the serving cell 505-d and the beams of the serving cell 505-e in accordance with the techniques described herein with reference to FIG. 4. Accordingly, the network entity may utilize such a mapping to schedule the transmission of the third message 531-b on the serving cell 505-e of the vCell 510-b.

For example, the network entity 105 scheduling the vCell 510-b, may map the beam 540-g of the serving cell 505-d to the beams 540-i and 540-j of the serving cell 505-e and also map the beam 540-h of the serving cell 505-d to the beams 540-k and 540-l of the serving cell 505-e. As such, the UE 115-b may receive such mappings via the SI 517-b. As such, if the UE 115-e transmits the first message 521-b, the network entity 105 may have an indication that the UE 115-e expects to transmit the third message 531-b via the beam 540-i, the beam 540-j, or both (e.g., according to the case indicated in the SI 517-b, as described herein with reference to FIG. 4). Accordingly, the network entity 105 may utilize such information to schedule the RACH resources for the third message 531-b in the second message 526-b.

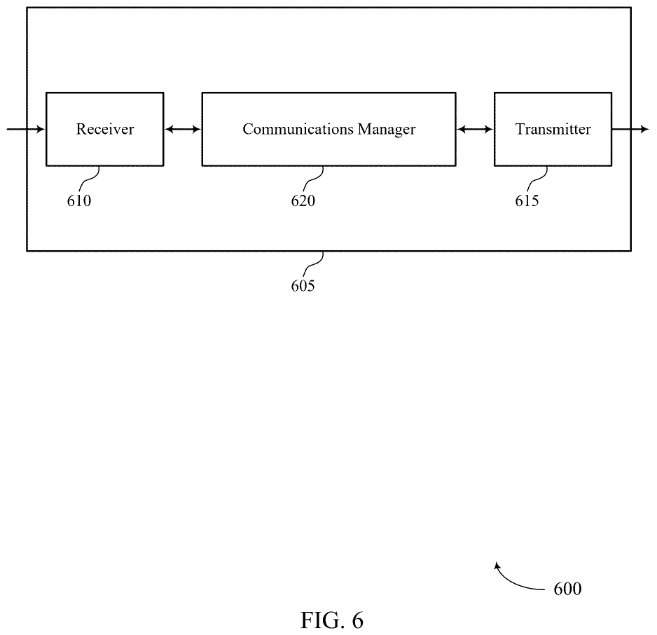

FIG. 6 shows a block diagram 600 of a device 605 that supports random-access procedures to access vCells in wireless communications systems in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to random-access procedures to access vCells in wireless communications systems). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to random-access procedures to access vCells in wireless communications systems). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of random-access procedures to access vCells in wireless communications systems as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for transmitting, via a first serving cell of a vCell, a first message of a RACH procedure to access a set of serving cells of the vCell. The communications manager 620 is capable of, configured to, or operable to support a means for receiving, via the first serving cell or a second serving cell of the vCell, a second message of the RACH procedure in response to transmission of the first message. The communications manager 620 is capable of, configured to, or operable to support a means for communicating via the set of serving cells of the vCell in accordance with successful performance of the RACH procedure.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for RACH procedures to access a vCell, which may provide for more efficient utilization of communication resources.

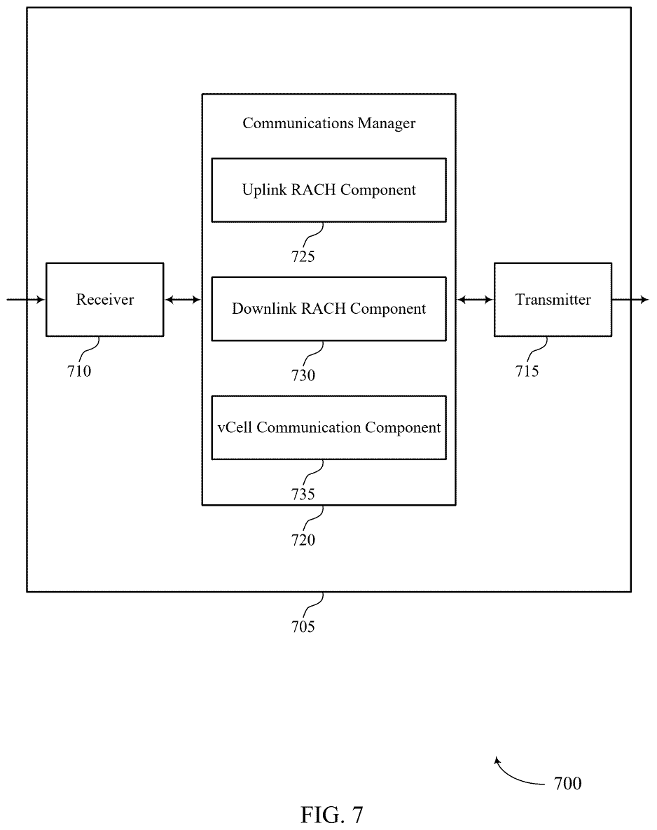

FIG. 7 shows a block diagram 700 of a device 705 that supports random-access procedures to access vCells in wireless communications systems in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to random-access procedures to access vCells in wireless communications systems). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to random-access procedures to access vCells in wireless communications systems). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of random-access procedures to access vCells in wireless communications systems as described herein. For example, the communications manager 720 may include an uplink RACH component 725, a downlink RACH component 730, a vCell communication component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The uplink RACH component 725 is capable of, configured to, or operable to support a means for transmitting, via a first serving cell of a vCell, a first message of a RACH procedure to access a set of serving cells of the vCell. The downlink RACH component 730 is capable of, configured to, or operable to support a means for receiving, via the first serving cell or a second serving cell of the vCell, a second message of the RACH procedure in response to transmission of the first message. The vCell communication component 735 is capable of, configured to, or operable to support a means for communicating via the set of serving cells of the vCell in accordance with successful performance of the RACH procedure.

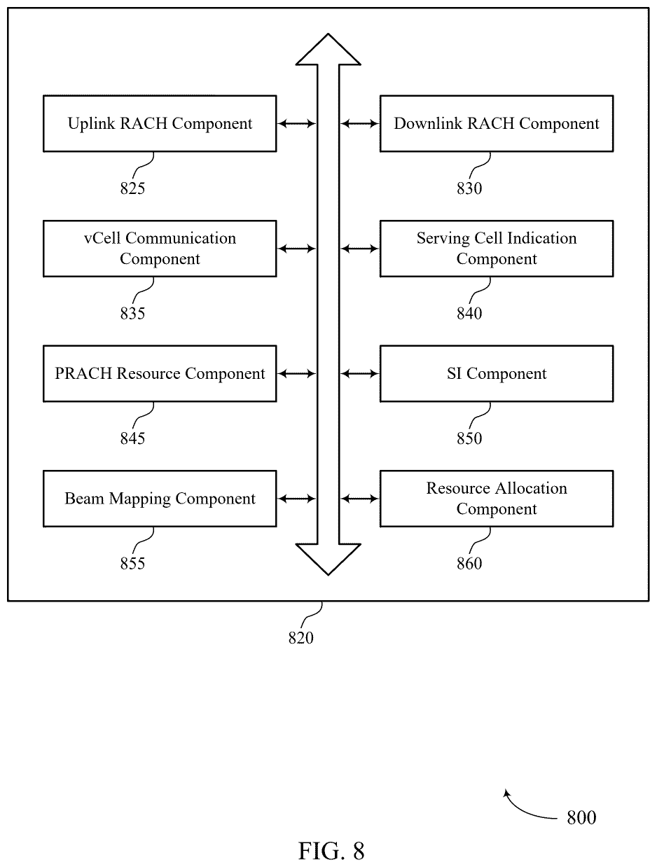

FIG. 8 shows a block diagram 800 of a communications manager 820 that supports random-access procedures to access vCells in wireless communications systems in accordance with one or more aspects of the present disclosure. The communications manager 820 may be an example of aspects of a communications manager 620, a communications manager 720, or both, as described herein. The communications manager 820, or various components thereof, may be an example of means for performing various aspects of random-access procedures to access vCells in wireless communications systems as described herein. For example, the communications manager 820 may include an uplink RACH component 825, a downlink RACH component 830, a vCell communication component 835, a serving cell indication component 840, a PRACH resource component 845, a SI component 850, a beam mapping component 855, a resource allocation component 860, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The uplink RACH component 825 is capable of, configured to, or operable to support a means for transmitting, via a first serving cell of a vCell, a first message of a RACH procedure to access a set of serving cells of the vCell. The downlink RACH component 830 is capable of, configured to, or operable to support a means for receiving, via the first serving cell or a second serving cell of the vCell, a second message of the RACH procedure in response to transmission of the first message. The vCell communication component 835 is capable of, configured to, or operable to support a means for communicating via the set of serving cells of the vCell in accordance with successful performance of the RACH procedure.

In some examples, the uplink RACH component 825 is capable of, configured to, or operable to support a means for transmitting, via the first serving cell, a third message of the RACH procedure in response to reception of the second message. In some examples, the downlink RACH component 830 is capable of, configured to, or operable to support a means for receiving, via the first serving cell or the second serving cell, a fourth message of the RACH procedure in response to reception of the third message, where communicating via the set of serving cells is further in accordance with reception of the fourth message.

In some examples, the first message, the third message, or both, include an indication that the UE is to access the vCell as a result of the successful performance of the RACH procedure.

In some examples, the serving cell indication component 840 is capable of, configured to, or operable to support a means for transmitting, prior to a security establishment procedure of the RACH procedure, signaling that indicates one or more serving cells of the set of serving cells via which the UE is to perform the RACH procedure, where the one or more serving cells include the first serving cell, the second serving cell, or both, and where the RACH procedure is performed in accordance with the signaling.

In some examples, the signaling further indicates at least a subset of serving cells of the set of serving cells with which the UE will communicate with after the successful performance of the RACH procedure. In some examples, the UE communicates via the subset of serving cells in accordance with the signaling.

In some examples, the resource allocation component 860 is capable of, configured to, or operable to support a means for receiving an indication of one or more resources allocated for transmission of the signaling, where the signaling is transmitted via the one or more resources.

In some examples, the second message is received via the first serving cell, and the PRACH resource component 845 is capable of, configured to, or operable to support a means for receiving, in response to the successful performance of the RACH procedure, a set of PRACH resources associated with an additional serving cell of the set of serving cells of the vCell. In some examples, the second message is received via the first serving cell, and the serving cell indication component 840 is capable of, configured to, or operable to support a means for transmitting a message to the additional serving cell of the vCell via the set of PRACH resources, where the message indicates a subset of the set of serving cells of the vCell with which the UE intends to communicate, a set of beams usable by the UE for communicating with the vCell, or both.

In some examples, the SI component 850 is capable of, configured to, or operable to support a means for receiving SI associated with the vCell, where the SI indicates a mapping between one or more first beams of a first set of beams associated with the first serving cell and one or more second beams of a second set of beams associated with the second serving cell, where the first message is transmitted via the one or more first beams associated with the first serving cell and the second message is received via the one or more second beams associated the second serving cell in accordance with the mapping.

In some examples, the SI further indicates that the UE is to monitor each beam of the one or more second beams for reception of the second message in response to transmission of the first message via the one or more first beams.

In some examples, the SI further indicates that the UE is to monitor any of the one or more second beams for reception of the second message in response to transmission of the first message via the one or more first beams.

In some examples, the one or more second beams associated with the second serving cell include beam characteristics that are the same or similar to beam characteristics of the one or more first beams associated with the first serving cell. In some examples, the beam characteristics include a beam direction, a beam width, or both.

In some examples, the SI further includes a timer associated with monitoring the one or more second beams associated with the second serving cell, and the downlink RACH component 830 is capable of, configured to, or operable to support a means for monitoring, for a duration of the timer, the one or more second beams for reception of the second message. In some examples, the SI further includes a timer associated with monitoring the one or more second beams associated with the second serving cell, and the downlink RACH component 830 is capable of, configured to, or operable to support a means for monitoring, in response to expiration of the timer and failing to receive the second message, one or more additional beams of the second set of beams associated with the second serving cell for reception of the second message, where reception of the second message is in accordance with monitoring the one or more additional beams of the second set of beams.

In some examples, the SI component 850 is capable of, configured to, or operable to support a means for receiving SI associated with the vCell, where the SI indicates a set of resources for reception of the second message, a timer associated with monitoring for the second message, a priority associated with each resource of the set of resources, or any combination thereof, where each resource of the set of resources is associated with a respective serving cell of the set of serving cells.

In some examples, to support receiving the second message, the downlink RACH component 830 is capable of, configured to, or operable to support a means for monitoring, for a duration of the timer, a first resource of the set of resources associated with the first serving cell for reception of the second message in accordance with the SI. In some examples, to support receiving the second message, the downlink RACH component 830 is capable of, configured to, or operable to support a means for monitoring, in response to expiration of the timer and failure to receive the second message via the first resource, a second resource of the set of resources associated with the second serving cell in accordance with the SI, where the second message is received via the second resource associated with the second serving cell.

In some examples, the SI component 850 is capable of, configured to, or operable to support a means for receiving SI associated with the vCell, where the SI indicates a set of resources for transmission of the first message, a probability associated with each resource of the set of resources, a selection rule associated with the set of resources, or any combination thereof, where the first message is transmitted in accordance with the SI.

In some examples, the SI component 850 is capable of, configured to, or operable to support a means for receiving SI associated with the vCell, where the SI includes a set of multiple mappings, where each mapping of the set of multiple mappings indicates a correspondence between one or more first beams of a first set of beams associated with the first serving cell and one or more second beams of a second set of beams associated with the second serving cell. In some examples, the beam mapping component 855 is capable of, configured to, or operable to support a means for transmitting, via the first message, an indication of a first mapping of the set of multiple mappings, where the first message is transmitted via a first beam associated with the first serving cell and the second message is received via a second beam associated the second serving cell in accordance with the first mapping.

In some examples, the first message and the second message are communicated via a first set of resources associated with the RACH procedure to access the vCell, and the first set of resources are different from a second set of resources that are associated with a second RACH procedure to access a second vCell.

In some examples, the first message and the second message are communicated via a first set of resources associated with the RACH procedure to access the vCell, and the first set of resources are different from a second set of resources that are associated with a second RACH procedure to access the first serving cell.

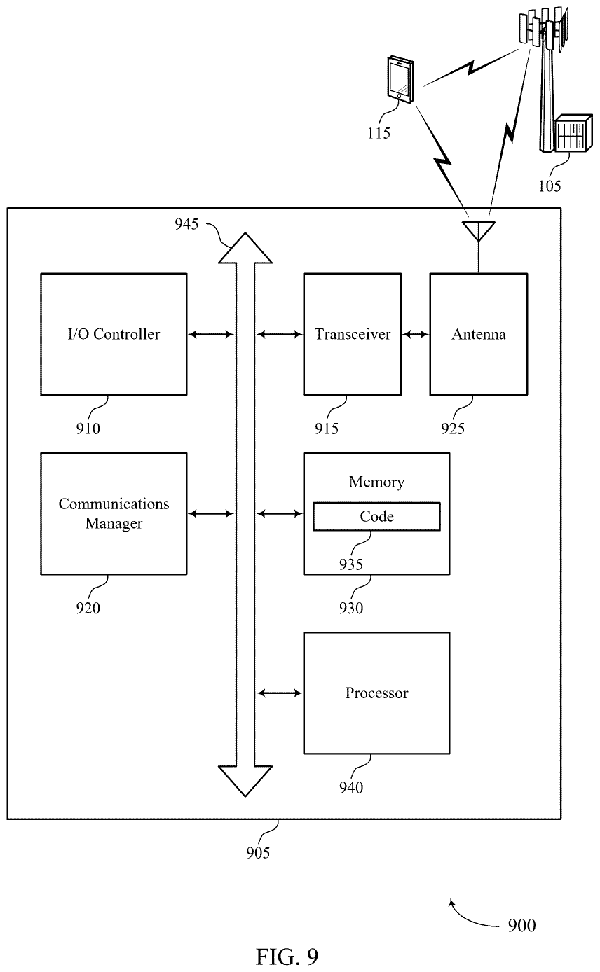

FIG. 9 shows a diagram of a system 900 including a device 905 that supports random-access procedures to access vCells in wireless communications systems in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random-access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting random-access procedures to access vCells in wireless communications systems). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for transmitting, via a first serving cell of a vCell, a first message of a RACH procedure to access a set of serving cells of the vCell. The communications manager 920 is capable of, configured to, or operable to support a means for receiving, via the first serving cell or a second serving cell of the vCell, a second message of the RACH procedure in response to transmission of the first message. The communications manager 920 is capable of, configured to, or operable to support a means for communicating via the set of serving cells of the vCell in accordance with successful performance of the RACH procedure.

By including or configuring the communications manager 920 in accordance with examples as described herein, the device 905 may support techniques for RACH procedures to access a vCell, which may provide for more efficient utilization of communication resources and improved coordination between devices, among other examples.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of random-access procedures to access vCells in wireless communications systems as described herein, or the at least one processor 940 and the at least one memory 930 may be otherwise configured to, individually or collectively, perform or support such operations.

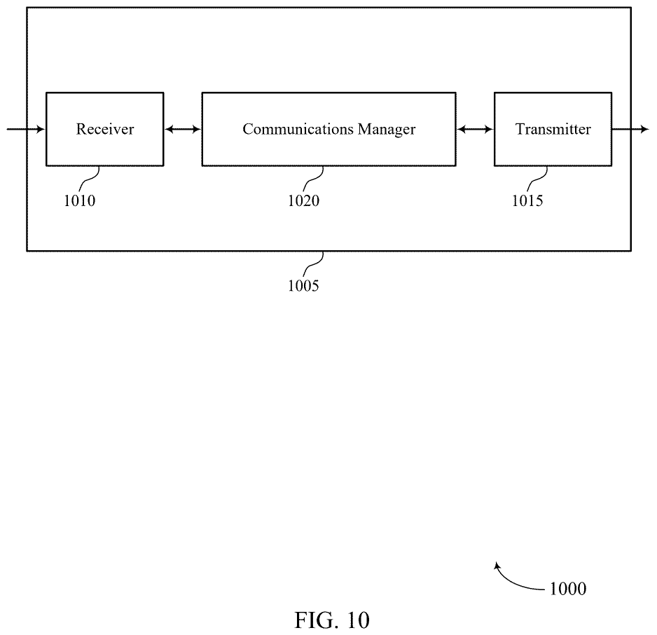

FIG. 10 shows a block diagram 1000 of a device 1005 that supports random-access procedures to access vCells in wireless communications systems in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of random-access procedures to access vCells in wireless communications systems as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for obtaining, via a first serving cell of a vCell managed by the network entity, a first message of a RACH procedure for a UE to obtain access to a set of serving cells of the vCell. The communications manager 1020 is capable of, configured to, or operable to support a means for outputting, via the first serving cell or a second serving cell of the vCell, a second message of the RACH procedure in response to obtainment of the first message. The communications manager 1020 is capable of, configured to, or operable to support a means for communicating via the set of serving cells of the vCell in accordance with successful performance of the RACH procedure.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for RACH procedures to access a vCell, which may provide for more efficient utilization of communication resources.

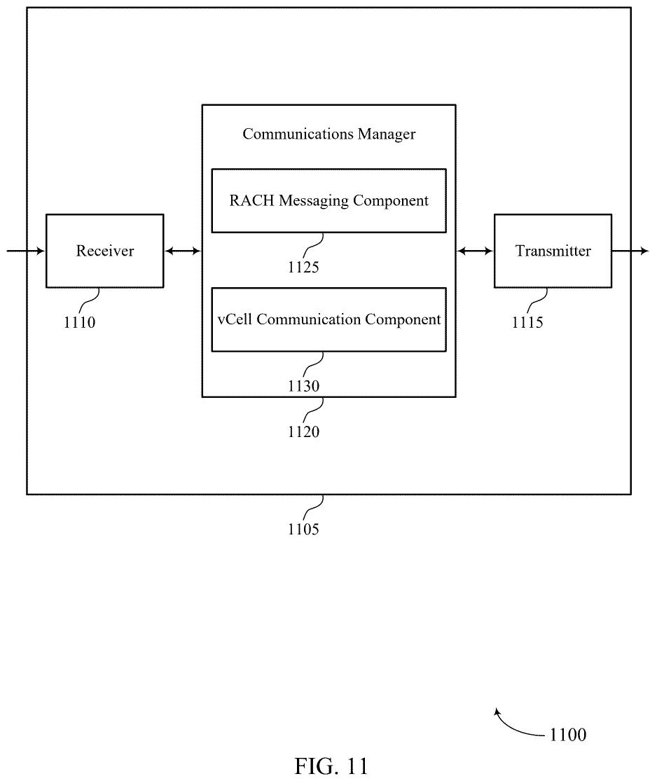

FIG. 11 shows a block diagram 1100 of a device 1105 that supports random-access procedures to access vCells in wireless communications systems in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of random-access procedures to access vCells in wireless communications systems as described herein. For example, the communications manager 1120 may include a RACH messaging component 1125 a vCell communication component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The RACH messaging component 1125 is capable of, configured to, or operable to support a means for obtaining, via a first serving cell of a vCell managed by the network entity, a first message of a RACH procedure for a UE to obtain access to a set of serving cells of the vCell. The RACH messaging component 1125 is capable of, configured to, or operable to support a means for outputting, via the first serving cell or a second serving cell of the vCell, a second message of the RACH procedure in response to obtainment of the first message. The vCell communication component 1130 is capable of, configured to, or operable to support a means for communicating via the set of serving cells of the vCell in accordance with successful performance of the RACH procedure.

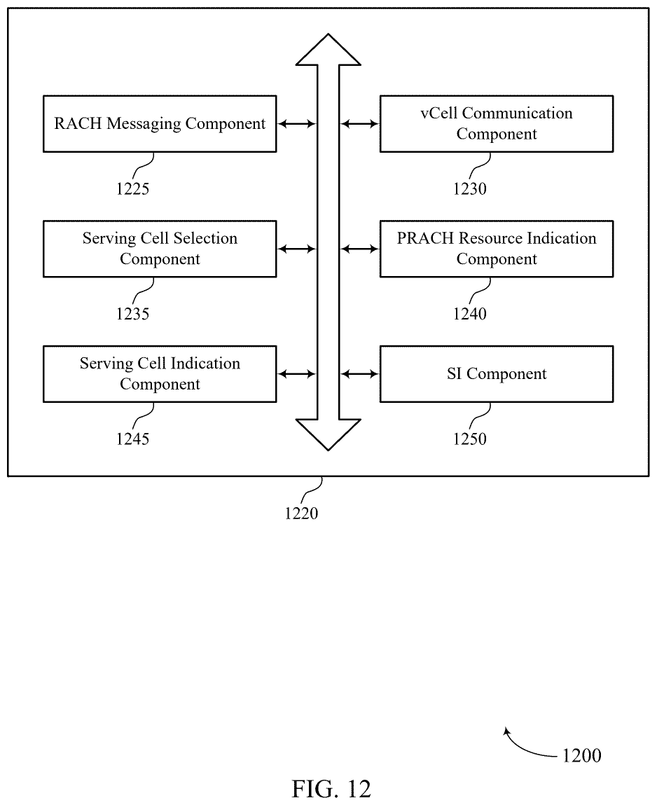

FIG. 12 shows a block diagram 1200 of a communications manager 1220 that supports random-access procedures to access vCells in wireless communications systems in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of random-access procedures to access vCells in wireless communications systems as described herein. For example, the communications manager 1220 may include a RACH messaging component 1225, a vCell communication component 1230, a serving cell selection component 1235, a PRACH resource indication component 1240, a serving cell indication component 1245, a SI component 1250, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The RACH messaging component 1225 is capable of, configured to, or operable to support a means for obtaining, via a first serving cell of a vCell managed by the network entity, a first message of a RACH procedure for a UE to obtain access to a set of serving cells of the vCell. In some examples, the RACH messaging component 1225 is capable of, configured to, or operable to support a means for outputting, via the first serving cell or a second serving cell of the vCell, a second message of the RACH procedure in response to obtainment of the first message. The vCell communication component 1230 is capable of, configured to, or operable to support a means for communicating via the set of serving cells of the vCell in accordance with successful performance of the RACH procedure.

In some examples, the RACH messaging component 1225 is capable of, configured to, or operable to support a means for obtaining, via the first serving cell, a third message of the RACH procedure in response to output of the second message. In some examples, the RACH messaging component 1225 is capable of, configured to, or operable to support a means for outputting, via the first serving cell or the second serving cell, a fourth message of the RACH procedure in response to output of the third message, where communicating via the set of serving cells is further in accordance with output of the fourth message.

In some examples, the first message, the third message, or both, include an indication that the UE is to access the vCell as a result of the successful performance of the RACH procedure.

In some examples, the serving cell selection component 1235 is capable of, configured to, or operable to support a means for obtaining, prior to a security establishment procedure of the RACH procedure, signaling that indicates one or more serving cells of the set of serving cells via which the UE is to perform the RACH procedure, where the one or more serving cells include the first serving cell, the second serving cell, or both, and where the RACH procedure is performed in accordance with the signaling.

In some examples, the signaling further indicates at least a subset of serving cells of the set of serving cells with which the UE will communicate with after the successful performance of the RACH procedure. In some examples, the UE communicates via the subset of serving cells in accordance with the signaling.

In some examples, the second message is output via the first serving cell, and the PRACH resource indication component 1240 is capable of, configured to, or operable to support a means for outputting, in response to the successful performance of the RACH procedure, a set of PRACH resources associated with an additional serving cell of the set of serving cells of the vCell. In some examples, the second message is output via the first serving cell, and the serving cell indication component 1245 is capable of, configured to, or operable to support a means for obtaining, at the additional serving cell, a message via the set of PRACH resources, where the message indicates a subset of the set of serving cells of the vCell with which the UE intends to communicate, a set of beams usable by the UE for communicating with the vCell, or both.

In some examples, the SI component 1250 is capable of, configured to, or operable to support a means for outputting SI associated with the vCell, where the SI indicates a mapping between one or more first beams of a first set of beams associated with the first serving cell and one or more second beams of a second set of beams associated with the second serving cell, where the first message is transmitted via the one or more first beams associated with the first serving cell and the second message is received via the one or more second beams associated the second serving cell in accordance with the mapping.

In some examples, the SI further indicates that the UE is to monitor each beam of the one or more second beams for output of the second message in response to obtainment of the first message via the one or more first beams.

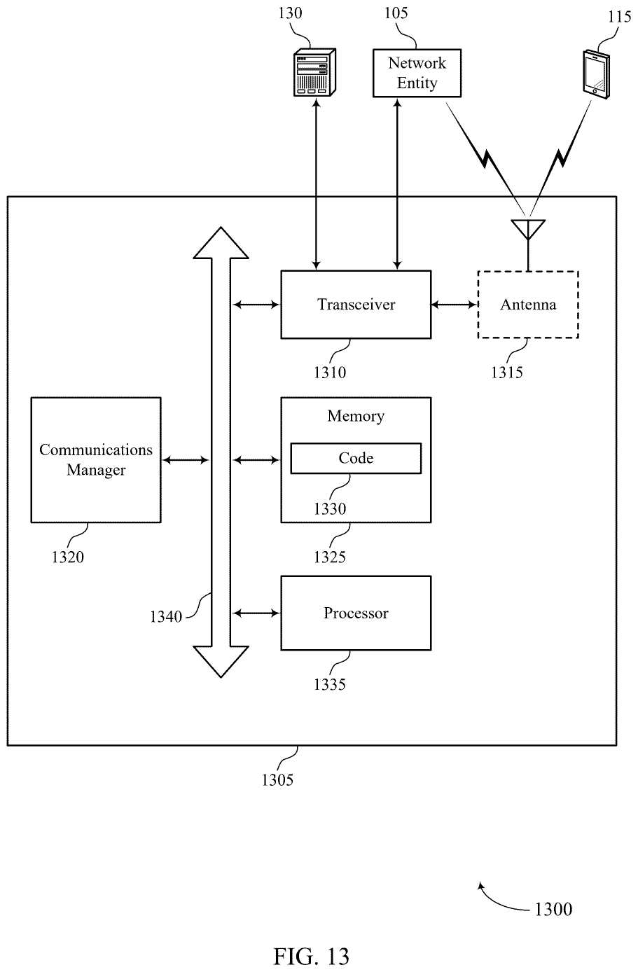

FIG. 13 shows a diagram of a system 1300 including a device 1305 that supports random-access procedures to access vCells in wireless communications systems in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting random-access procedures to access vCells in wireless communications systems). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for obtaining, via a first serving cell of a vCell managed by the network entity, a first message of a RACH procedure for a UE to obtain access to a set of serving cells of the vCell. The communications manager 1320 is capable of, configured to, or operable to support a means for outputting, via the first serving cell or a second serving cell of the vCell, a second message of the RACH procedure in response to obtainment of the first message. The communications manager 1320 is capable of, configured to, or operable to support a means for communicating via the set of serving cells of the vCell in accordance with successful performance of the RACH procedure.

By including or configuring the communications manager 1320 in accordance with examples as described herein, the device 1305 may support techniques for RACH procedures to access a vCell, which may provide for more efficient utilization of communication resources and improved coordination between devices, among other examples.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of random-access procedures to access vCells in wireless communications systems as described herein, or the at least one processor 1335 and the at least one memory 1325 may be otherwise configured to, individually or collectively, perform or support such operations.

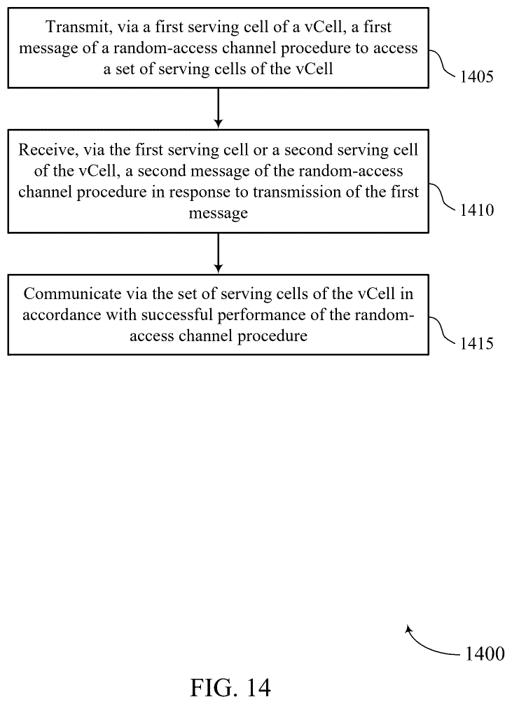

FIG. 14 shows a flowchart illustrating a method 1400 that supports random-access procedures to access vCells in wireless communications systems in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting, via a first serving cell of a vCell, a first message of a RACH procedure to access a set of serving cells of the vCell. The operations of 1405 may be performed in accordance with examples as disclosed herein. In some examples, aspects of the operations of 1405 may be performed by an uplink RACH component 825 as described with reference to FIG. 8.

At 1410, the method may include receiving, via the first serving cell or a second serving cell of the vCell, a second message of the RACH procedure in response to transmission of the first message. The operations of 1410 may be performed in accordance with examples as disclosed herein. In some examples, aspects of the operations of 1410 may be performed by a downlink RACH component 830 as described with reference to FIG. 8.

At 1415, the method may include communicating via the set of serving cells of the vCell in accordance with successful performance of the RACH procedure. The operations of 1415 may be performed in accordance with examples as disclosed herein. In some examples, aspects of the operations of 1415 may be performed by a vCell communication component 835 as described with reference to FIG. 8.

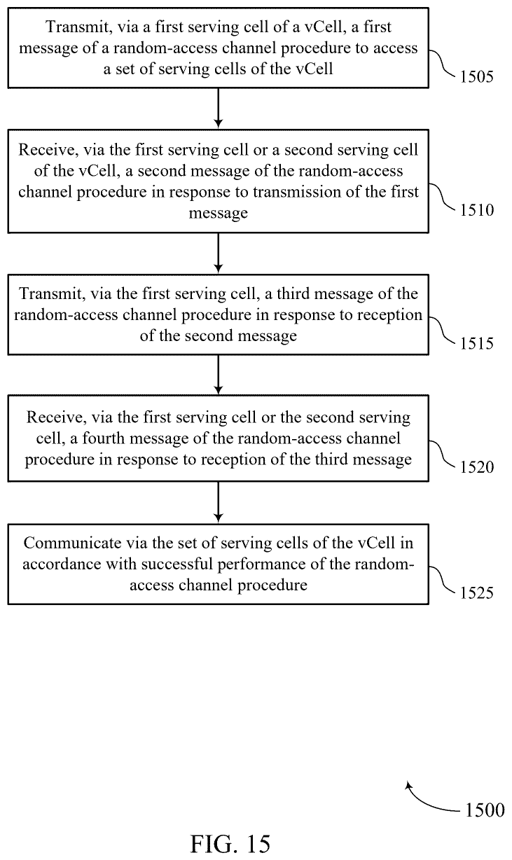

FIG. 15 shows a flowchart illustrating a method 1500 that supports random-access procedures to access vCells in wireless communications systems in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting, via a first serving cell of a vCell, a first message of a RACH procedure to access a set of serving cells of the vCell. The operations of 1505 may be performed in accordance with examples as disclosed herein. In some examples, aspects of the operations of 1505 may be performed by an uplink RACH component 825 as described with reference to FIG. 8.

At 1510, the method may include receiving, via the first serving cell or a second serving cell of the vCell, a second message of the RACH procedure in response to transmission of the first message. The operations of 1510 may be performed in accordance with examples as disclosed herein. In some examples, aspects of the operations of 1510 may be performed by a downlink RACH component 830 as described with reference to FIG. 8.

At 1515, the method may include transmitting, via the first serving cell, a third message of the RACH procedure in response to reception of the second message. The operations of 1515 may be performed in accordance with examples as disclosed herein. In some examples, aspects of the operations of 1515 may be performed by an uplink RACH component 825 as described with reference to FIG. 8.

At 1520, the method may include receiving, via the first serving cell or the second serving cell, a fourth message of the RACH procedure in response to reception of the third message. The operations of 1520 may be performed in accordance with examples as disclosed herein. In some examples, aspects of the operations of 1520 may be performed by a downlink RACH component 830 as described with reference to FIG. 8.

At 1525, the method may include communicating via the set of serving cells of the vCell in accordance with successful performance of the RACH procedure. The operations of 1525 may be performed in accordance with examples as disclosed herein. In some examples, aspects of the operations of 1525 may be performed by a vCell communication component 835 as described with reference to FIG. 8.

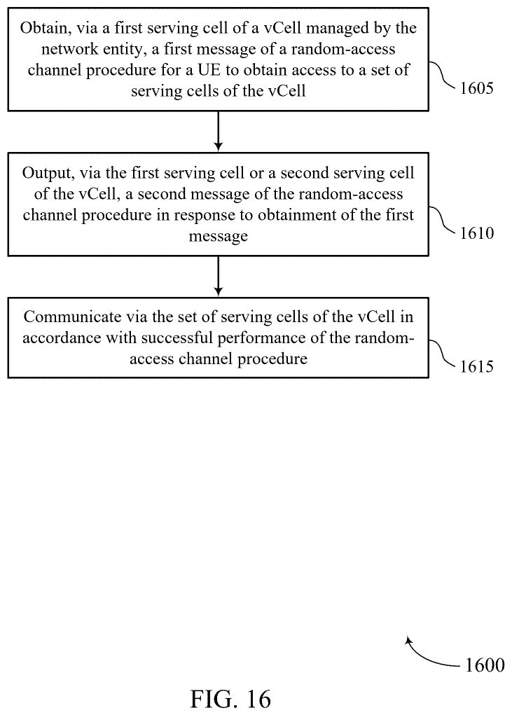

FIG. 16 shows a flowchart illustrating a method 1600 that supports random-access procedures to access vCells in wireless communications systems in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include obtaining, via a first serving cell of a vCell managed by the network entity, a first message of a RACH procedure for a UE to obtain access to a set of serving cells of the vCell. The operations of 1605 may be performed in accordance with examples as disclosed herein. In some examples, aspects of the operations of 1605 may be performed by a RACH messaging component 1225 as described with reference to FIG. 12.

At 1610, the method may include outputting, via the first serving cell or a second serving cell of the vCell, a second message of the RACH procedure in response to obtainment of the first message. The operations of 1610 may be performed in accordance with examples as disclosed herein. In some examples, aspects of the operations of 1610 may be performed by a RACH messaging component 1225 as described with reference to FIG. 12.

At 1615, the method may include communicating via the set of serving cells of the vCell in accordance with successful performance of the RACH procedure. The operations of 1615 may be performed in accordance with examples as disclosed herein. In some examples, aspects of the operations of 1615 may be performed by a vCell communication component 1230 as described with reference to FIG. 12.

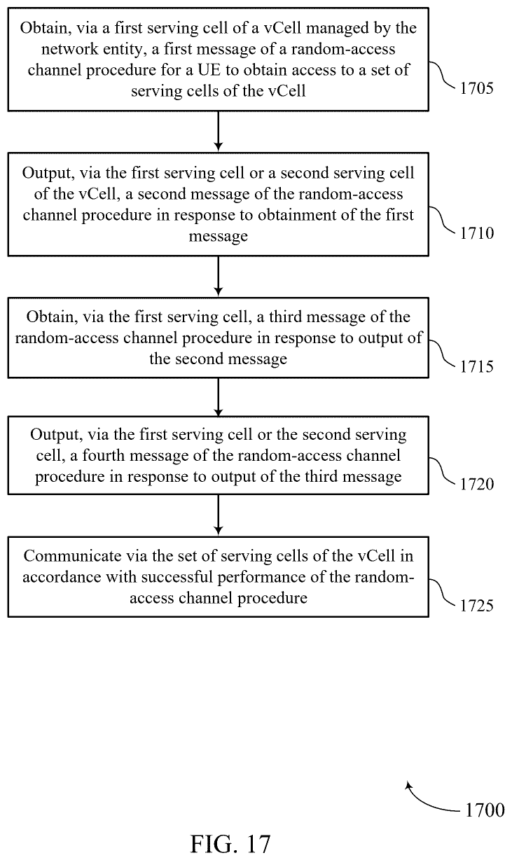

FIG. 17 shows a flowchart illustrating a method 1700 that supports random-access procedures to access vCells in wireless communications systems in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include obtaining, via a first serving cell of a vCell managed by the network entity, a first message of a RACH procedure for a UE to obtain access to a set of serving cells of the vCell. The operations of 1705 may be performed in accordance with examples as disclosed herein. In some examples, aspects of the operations of 1705 may be performed by a RACH messaging component 1225 as described with reference to FIG. 12.

At 1710, the method may include outputting, via the first serving cell or a second serving cell of the vCell, a second message of the RACH procedure in response to obtainment of the first message. The operations of 1710 may be performed in accordance with examples as disclosed herein. In some examples, aspects of the operations of 1710 may be performed by a RACH messaging component 1225 as described with reference to FIG. 12.

At 1715, the method may include obtaining, via the first serving cell, a third message of the RACH procedure in response to output of the second message. The operations of 1715 may be performed in accordance with examples as disclosed herein. In some examples, aspects of the operations of 1715 may be performed by a RACH messaging component 1225 as described with reference to FIG. 12.

At 1720, the method may include outputting, via the first serving cell or the second serving cell, a fourth message of the RACH procedure in response to output of the third message. The operations of 1720 may be performed in accordance with examples as disclosed herein. In some examples, aspects of the operations of 1720 may be performed by a RACH messaging component 1225 as described with reference to FIG. 12.

At 1725, the method may include communicating via the set of serving cells of the vCell in accordance with successful performance of the RACH procedure. The operations of 1725 may be performed in accordance with examples as disclosed herein. In some examples, aspects of the operations of 1725 may be performed by a vCell communication component 1230 as described with reference to FIG. 12.

The following provides an overview of aspects of the present disclosure:

Aspect 1: A method for wireless communications at a UE, comprising: transmitting, via a first serving cell of a vCell, a first message of a RACH procedure to access a set of serving cells of the vCell; receiving, via the first serving cell or a second serving cell of the vCell, a second message of the RACH procedure in response to transmission of the first message; and communicating via the set of serving cells of the vCell in accordance with successful performance of the RACH procedure.

Aspect 2: The method of aspect 1, further comprising: transmitting, via the first serving cell, a third message of the RACH procedure in response to reception of the second message; and receiving, via the first serving cell or the second serving cell, a fourth message of the RACH procedure in response to reception of the third message, wherein communicating via the set of serving cells is further in accordance with reception of the fourth message.

Aspect 3: The method of aspect 2, wherein the first message, the third message, or both, comprise an indication that the UE is to access the vCell as a result of the successful performance of the RACH procedure.

Aspect 4: The method of any of aspects 1 through 3, further comprising: transmitting, prior to a security establishment procedure of the RACH procedure, signaling that indicates one or more serving cells of the set of serving cells via which the UE is to perform the RACH procedure, wherein the one or more serving cells include the first serving cell, the second serving cell, or both, and wherein the RACH procedure is performed in accordance with the signaling.

Aspect 5: The method of aspect 4, wherein the signaling further indicates at least a subset of serving cells of the set of serving cells with which the UE will communicate with after the successful performance of the RACH procedure, and the UE communicates via the subset of serving cells in accordance with the signaling.

Aspect 6: The method of any of aspects 4 through 5, further comprising: receiving an indication of one or more resources allocated for transmission of the signaling, wherein the signaling is transmitted via the one or more resources.

Aspect 7: The method of any of aspects 1 through 6, wherein the second message is received via the first serving cell, the method further comprising: receiving, in response to the successful performance of the RACH procedure, a set of PRACH resources associated with an additional serving cell of the set of serving cells of the vCell; and transmitting a message to the additional serving cell of the vCell via the set of PRACH resources, wherein the message indicates a subset of the set of serving cells of the vCell with which the UE intends to communicate, a set of beams usable by the UE for communicating with the vCell, or both.

Aspect 8: The method of any of aspects 1 through 7, further comprising: receiving SI associated with the vCell, wherein the SI indicates a mapping between one or more first beams of a first set of beams associated with the first serving cell and one or more second beams of a second set of beams associated with the second serving cell, wherein the first message is transmitted via the one or more first beams associated with the first serving cell and the second message is received via the one or more second beams associated the second serving cell in accordance with the mapping.

Aspect 9: The method of aspect 8, wherein the SI further indicates that the UE is to monitor each beam of the one or more second beams for reception of the second message in response to transmission of the first message via the one or more first beams.

Aspect 10: The method of any of aspects 8 through 9, wherein the SI further indicates that the UE is to monitor any of the one or more second beams for reception of the second message in response to transmission of the first message via the one or more first beams.

Aspect 11: The method of any of aspects 8 through 10, wherein the one or more second beams associated with the second serving cell comprise beam characteristics that are the same or similar to beam characteristics of the one or more first beams associated with the first serving cell, and the beam characteristics comprise a beam direction, a beam width, or both.

Aspect 12: The method of any of aspects 8 through 11, wherein the SI further comprises a timer associated with monitoring the one or more second beams associated with the second serving cell, the method further comprising: monitoring, for a duration of the timer, the one or more second beams for reception of the second message; and monitoring, in response to expiration of the timer and failing to receive the second message, one or more additional beams of the second set of beams associated with the second serving cell for reception of the second message, wherein reception of the second message is in accordance with monitoring the one or more additional beams of the second set of beams.

Aspect 13: The method of any of aspects 1 through 12, further comprising: receiving SI associated with the vCell, wherein the SI indicates a set of resources for reception of the second message, a timer associated with monitoring for the second message, a priority associated with each resource of the set of resources, or any combination thereof, wherein each resource of the set of resources is associated with a respective serving cell of the set of serving cells.

Aspect 14: The method of aspect 13, wherein receiving the second message comprises: monitoring, for a duration of the timer, a first resource of the set of resources associated with the first serving cell for reception of the second message in accordance with the SI; and monitoring, in response to expiration of the timer and failure to receive the second message via the first resource, a second resource of the set of resources associated with the second serving cell in accordance with the SI, wherein the second message is received via the second resource associated with the second serving cell.

Aspect 15: The method of any of aspects 1 through 14, further comprising: receiving SI associated with the vCell, wherein the SI indicates a set of resources for transmission of the first message, a probability associated with each resource of the set of resources, a selection rule associated with the set of resources, or any combination thereof, wherein the first message is transmitted in accordance with the SI.

Aspect 16: The method of any of aspects 1 through 15, further comprising: receiving SI associated with the vCell, wherein the SI comprises a plurality of mappings, wherein each mapping of the plurality of mappings indicates a correspondence between one or more first beams of a first set of beams associated with the first serving cell and one or more second beams of a second set of beams associated with the second serving cell; and transmitting, via the first message, an indication of a first mapping of the plurality of mappings, wherein the first message is transmitted via a first beam associated with the first serving cell and the second message is received via a second beam associated the second serving cell in accordance with the first mapping.

Aspect 17: The method of any of aspects 1 through 16, wherein the first message and the second message are communicated via a first set of resources associated with the RACH procedure to access the vCell, and the first set of resources are different from a second set of resources that are associated with a second RACH procedure to access a second vCell.

Aspect 18: The method of any of aspects 1 through 17, wherein the first message and the second message are communicated via a first set of resources associated with the RACH procedure to access the vCell, and the first set of resources are different from a second set of resources that are associated with a second RACH procedure to access the first serving cell.

Aspect 19: A method for wireless communications at a network entity, comprising: obtaining, via a first serving cell of a vCell managed by the network entity, a first message of a RACH procedure for a UE to obtain access to a set of serving cells of the vCell; outputting, via the first serving cell or a second serving cell of the vCell, a second message of the RACH procedure in response to obtainment of the first message; and communicating via the set of serving cells of the vCell in accordance with successful performance of the RACH procedure.

Aspect 20: The method of aspect 19, further comprising: obtaining, via the first serving cell, a third message of the RACH procedure in response to output of the second message; and outputting, via the first serving cell or the second serving cell, a fourth message of the RACH procedure in response to output of the third message, wherein communicating via the set of serving cells is further in accordance with output of the fourth message.

Aspect 21: The method of aspect 20, wherein the first message, the third message, or both, comprise an indication that the UE is to access the vCell as a result of the successful performance of the RACH procedure.

Aspect 22: The method of any of aspects 19 through 21, further comprising: obtaining, prior to a security establishment procedure of the RACH procedure, signaling that indicates one or more serving cells of the set of serving cells via which the UE is to perform the RACH procedure, wherein the one or more serving cells include the first serving cell, the second serving cell, or both, and wherein the RACH procedure is performed in accordance with the signaling.

Aspect 23: The method of aspect 22, wherein the signaling further indicates at least a subset of serving cells of the set of serving cells with which the UE will communicate with after the successful performance of the RACH procedure, and the UE communicates via the subset of serving cells in accordance with the signaling.

Aspect 24: The method of any of aspects 19 through 23, wherein the second message is output via the first serving cell, the method further comprising: outputting, in response to the successful performance of the RACH procedure, a set of PRACH resources associated with an additional serving cell of the set of serving cells of the vCell; and obtaining, at the additional serving cell, a message via the set of PRACH resources, wherein the message indicates a subset of the set of serving cells of the vCell with which the UE intends to communicate, a set of beams usable by the UE for communicating with the vCell, or both.

Aspect 25: The method of any of aspects 19 through 24, further comprising: outputting SI associated with the vCell, wherein the SI indicates a mapping between one or more first beams of a first set of beams associated with the first serving cell and one or more second beams of a second set of beams associated with the second serving cell, wherein the first message is transmitted via the one or more first beams associated with the first serving cell and the second message is received via the one or more second beams associated the second serving cell in accordance with the mapping.

Aspect 26: The method of aspect 25, wherein the SI further indicates that the UE is to monitor each beam of the one or more second beams for output of the second message in response to obtainment of the first message via the one or more first beams.

Aspect 27: A UE for wireless communications, comprising one or more memories storing processor-executable code, and one or more processors coupled with the one or more memories and individually or collectively operable to execute the code to cause the UE to perform a method of any of aspects 1 through 18.

Aspect 28: A UE for wireless communications, comprising at least one means for performing a method of any of aspects 1 through 18.

Aspect 29: A non-transitory computer-readable medium storing code for wireless communications, the code comprising instructions executable by one or more processors to perform a method of any of aspects 1 through 18.

Aspect 30: A network entity for wireless communications, comprising one or more memories storing processor-executable code, and one or more processors coupled with the one or more memories and individually or collectively operable to execute the code to cause the network entity to perform a method of any of aspects 19 through 26.

Aspect 31: A network entity for wireless communications, comprising at least one means for performing a method of any of aspects 19 through 26.

Aspect 32: A non-transitory computer-readable medium storing code for wireless communications, the code comprising instructions executable by one or more processors to perform a method of any of aspects 19 through 26.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, via a first serving cell of a virtual cell, a first message of a random-access channel procedure to access a set of serving cells of the virtual cell;
receive, via the first serving cell or a second serving cell of the virtual cell, a second message of the random-access channel procedure in response to transmission of the first message; and
communicate via the set of serving cells of the virtual cell in accordance with successful performance of the random-access channel procedure.

2. The UE of claim 1, wherein the one or more processors are individually or collectively further operable to execute the code to cause the UE to:
transmit, via the first serving cell, a third message of the random-access channel procedure in response to reception of the second message; and
receive, via the first serving cell or the second serving cell, a fourth message of the random-access channel procedure in response to reception of the third message, wherein communications via the set of serving cells are further in accordance with reception of the fourth message.

3. The UE of claim 2, wherein the first message, the third message, or both, comprise an indication that the UE is to access the virtual cell as a result of the successful performance of the random-access channel procedure.

4. The UE of claim 1, wherein the one or more processors are individually or collectively further operable to execute the code to cause the UE to:
transmit, prior to a security establishment procedure of the random-access channel procedure, signaling that indicates one or more serving cells of the set of serving cells via which the UE is to perform the random-access channel procedure, wherein the one or more serving cells include the first serving cell, the second serving cell, or both, and wherein the random-access channel procedure is performed in accordance with the signaling.

5. The UE of claim 4, wherein the signaling further indicates at least a subset of serving cells of the set of serving cells with which the UE will communicate with after the successful performance of the random-access channel procedure, and wherein the UE communicates via the subset of serving cells in accordance with the signaling.

6. The UE of claim 4, wherein the one or more processors are individually or collectively further operable to execute the code to cause the UE to:
receive an indication of one or more resources allocated for transmission of the signaling, wherein the signaling is transmitted via the one or more resources.

7. The UE of claim 1, wherein the second message is received via the first serving cell, and the one or more processors are individually or collectively further operable to execute the code to cause the UE to:
receive, in response to the successful performance of the random-access channel procedure, a set of physical random-access channel resources associated with an additional serving cell of the set of serving cells of the virtual cell; and
transmit a message to the additional serving cell of the virtual cell via the set of physical random-access channel resources, wherein the message indicates a subset of the set of serving cells of the virtual cell with which the UE intends to communicate, a set of beams usable by the UE for communications with the virtual cell, or both.

8. The UE of claim 1, wherein the one or more processors are individually or collectively further operable to execute the code to cause the UE to:
receive system information associated with the virtual cell, wherein the system information indicates a mapping between one or more first beams of a first set of beams associated with the first serving cell and one or more second beams of a second set of beams associated with the second serving cell, wherein the first message is transmitted via the one or more first beams associated with the first serving cell and the second message is received via the one or more second beams associated the second serving cell in accordance with the mapping.

9. The UE of claim 8, wherein the system information further indicates that the UE is to monitor each beam of the one or more second beams for reception of the second message in response to transmission of the first message via the one or more first beams.

10. The UE of claim 8, wherein the system information further indicates that the UE is to monitor any of the one or more second beams for reception of the second message in response to transmission of the first message via the one or more first beams.

11. The UE of claim 8, wherein the one or more second beams associated with the second serving cell comprise beam characteristics that are the same or similar to beam characteristics of the one or more first beams associated with the first serving cell, and wherein the beam characteristics comprise a beam direction, a beam width, or both.

12. The UE of claim 8, wherein the system information further comprises a timer associated with monitoring the one or more second beams associated with the second serving cell, and the one or more processors are individually or collectively further operable to execute the code to cause the UE to:
monitor, for a duration of the timer, the one or more second beams for reception of the second message; and
monitor, in response to expiration of the timer and failure to receive the second message, one or more additional beams of the second set of beams associated with the second serving cell for reception of the second message, wherein reception of the second message is in accordance with monitoring the one or more additional beams of the second set of beams.

13. The UE of claim 1, wherein the one or more processors are individually or collectively further operable to execute the code to cause the UE to:
receive system information associated with the virtual cell, wherein the system information indicates a set of resources for reception of the second message, a timer associated with monitoring for the second message, a priority associated with each resource of the set of resources, or any combination thereof, wherein each resource of the set of resources is associated with a respective serving cell of the set of serving cells.

14. The UE of claim 13, wherein, to receive the second message, the one or more processors are individually or collectively operable to execute the code to cause the UE to:
monitor, for a duration of the timer, a first resource of the set of resources associated with the first serving cell for reception of the second message in accordance with the system information; and
monitor, in response to expiration of the timer and failure to receive the second message via the first resource, a second resource of the set of resources associated with the second serving cell in accordance with the system information, wherein the second message is received via the second resource associated with the second serving cell.

15. The UE of claim 1, wherein the one or more processors are individually or collectively further operable to execute the code to cause the UE to:
receive system information associated with the virtual cell, wherein the system information indicates a set of resources for transmission of the first message, a probability associated with each resource of the set of resources, a selection rule associated with the set of resources, or any combination thereof, wherein the first message is transmitted in accordance with the system information.

16. The UE of claim 1, wherein the one or more processors are individually or collectively further operable to execute the code to cause the UE to:
receive system information associated with the virtual cell, wherein the system information comprises a plurality of mappings, wherein each mapping of the plurality of mappings indicates a correspondence between one or more first beams of a first set of beams associated with the first serving cell and one or more second beams of a second set of beams associated with the second serving cell; and
transmit, via the first message, an indication of a first mapping of the plurality of mappings, wherein the first message is transmitted via a first beam associated with the first serving cell and the second message is received via a second beam associated the second serving cell in accordance with the first mapping.

17. The UE of claim 1, wherein:
the first message and the second message are communicated via a first set of resources associated with the random-access channel procedure to access the virtual cell, and
the first set of resources are different from a second set of resources that are associated with a second random-access channel procedure to access a second virtual cell.

18. The UE of claim 1, wherein:
the first message and the second message are communicated via a first set of resources associated with the random-access channel procedure to access the virtual cell, and
the first set of resources are different from a second set of resources that are associated with a second random-access channel procedure to access the first serving cell.

19. A network entity, comprising:
one or more memories storing processor-executable code; and
one or more processors coupled with the one or more memories and individually or collectively operable to execute the code to cause the network entity to:
obtain, via a first serving cell of a virtual cell managed by the network entity, a first message of a random-access channel procedure for a user equipment (UE) to obtain access to a set of serving cells of the virtual cell;
output, via the first serving cell or a second serving cell of the virtual cell, a second message of the random-access channel procedure in response to obtainment of the first message; and
communicate via the set of serving cells of the virtual cell in accordance with successful performance of the random-access channel procedure.

20. The network entity of claim 19, wherein the one or more processors are individually or collectively further operable to execute the code to cause the network entity to:
obtain, via the first serving cell, a third message of the random-access channel procedure in response to output of the second message; and
output, via the first serving cell or the second serving cell, a fourth message of the random-access channel procedure in response to output of the third message, wherein communicating via the set of serving cells is further in accordance with output of the fourth message.

21. The network entity of claim 20, wherein the first message, the third message, or both, comprise an indication that the UE is to access the virtual cell as a result of the successful performance of the random-access channel procedure.

22. The network entity of claim 19, wherein the one or more processors are individually or collectively further operable to execute the code to cause the network entity to:
obtain, prior to a security establishment procedure of the random-access channel procedure, signaling that indicates one or more serving cells of the set of serving cells via which the UE is to perform the random-access channel procedure, wherein the one or more serving cells include the first serving cell, the second serving cell, or both, and wherein the random-access channel procedure is performed in accordance with the signaling.

23. The network entity of claim 22, wherein the signaling further indicates at least a subset of serving cells of the set of serving cells with which the UE will communicate with after the successful performance of the random-access channel procedure, and the UE communicates via the subset of serving cells in accordance with the signaling.

24. The network entity of claim 19, wherein the second message is output via the first serving cell, and the one or more processors are individually or collectively further operable to execute the code to cause the network entity to:
output, in response to the successful performance of the random-access channel procedure, a set of physical random-access channel resources associated with an additional serving cell of the set of serving cells of the virtual cell; and
obtain, at the additional serving cell, a message via the set of physical random-access channel resources, wherein the message indicates a subset of the set of serving cells of the virtual cell with which the UE intends to communicate, a set of beams usable by the UE for communications with the virtual cell, or both.

25. The network entity of claim 19, wherein the one or more processors are individually or collectively further operable to execute the code to cause the network entity to:
output system information associated with the virtual cell, wherein the system information indicates a mapping between one or more first beams of a first set of beams associated with the first serving cell and one or more second beams of a second set of beams associated with the second serving cell, wherein the first message is transmitted via the one or more first beams associated with the first serving cell and the second message is received via the one or more second beams associated the second serving cell in accordance with the mapping.

26. The network entity of claim 25, wherein the system information further indicates that the UE is to monitor each beam of the one or more second beams for output of the second message in response to obtainment of the first message via the one or more first beams.

27. A method for wireless communications at a user equipment (UE), comprising:
transmitting, via a first serving cell of a virtual cell, a first message of a random-access channel procedure to access a set of serving cells of the virtual cell;
receiving, via the first serving cell or a second serving cell of the virtual cell, a second message of the random-access channel procedure in response to transmission of the first message; and
communicating via the set of serving cells of the virtual cell in accordance with successful performance of the random-access channel procedure.

28. The method of claim 27, further comprising:
transmitting, via the first serving cell, a third message of the random-access channel procedure in response to reception of the second message; and
receiving, via the first serving cell or the second serving cell, a fourth message of the random-access channel procedure in response to reception of the third message, wherein communicating via the set of serving cells is further in accordance with reception of the fourth message.

29. The method of claim 28, wherein the first message, the third message, or both, comprise an indication that the UE is to access the virtual cell as a result of the successful performance of the random-access channel procedure.

30. A method for wireless communications at a network entity, comprising:
obtaining, via a first serving cell of a virtual cell managed by the network entity, a first message of a random-access channel procedure for a user equipment (UE) to obtain access to a set of serving cells of the virtual cell;
outputting, via the first serving cell or a second serving cell of the virtual cell, a second message of the random-access channel procedure in response to obtainment of the first message; and
communicating via the set of serving cells of the virtual cell in accordance with successful performance of the random-access channel procedure.
